(19) United States
(12) Patent Application Publication
(10) Pub. No.: US 2015/0286293 A1
(43) Pub. Date: Oct. 8, 2015

(54) OPTICAL STYLUS WITH DEFORMABLE TIP

(71) Applicant: QUALCOMM Incorporated, San Diego, CA (US)

(72) Inventors: Russell Wayne Gruhlke, Milpitas, CA (US); Suryaprakash Ganti, Los Altos, CA (US); Ying Zhou, Milpitas, CA (US); Khurshid Syed Alam, Mountain View, CA (US)

(73) Assignee: QUALCOMM Incorporated, San Diego, CA (US)

(21) Appl. No.: 14/244,762

(22) Filed: Apr. 3, 2014

(51) Int. Cl. G06F 3/0354

(52) U.S. Cl. CPC G06F 3/03542

(57) ABSTRACT

An optical stylus may be capable of providing active illumination for a touch/proximity sensing apparatus. The optical stylus also may be capable of determining a tilt angle of the optical stylus and/or an amount of pressure exerted upon the optical stylus. In some examples, an optical stylus may determine a tilt angle and/or pressure according to changes in optical flux distributions inside the optical stylus. In some examples, an optical stylus may include a deformable tip. The deformable tip and/or associated features may be capable of altering optical flux distributions inside the optical stylus in response to applied pressure and/or optical stylus tilt. In some implementations, the optical flux provided to the light guide by the optical stylus may vary according to pressure applied to the optical stylus.

### TECHNICAL FIELD

This disclosure relates generally to touch sensor systems and gesture-detection systems.

### DESCRIPTION OF THE RELATED TECHNOLOGY

The basic function of a touch sensing device is to convert the detected presence of a finger, stylus or pen near or on a touch screen into position information. Such position information can be used as input for further action on a mobile phone, a computer, or another such device. Various types of touch sensing devices are currently in use. Some are based on detected changes in resistivity or capacitance, on acoustical responses, etc. At present, the most widely used touch sensing techniques are projected capacitance methods, wherein the presence of a conductive body (such as a finger, a conductive stylus, etc.) on or near the cover glass of a display is sensed as a change in the local capacitance between a pair of wires. In some implementations, the pair of wires may be on the inside surface of a substantially transparent cover substrate (a “cover glass”) or a substantially transparent display substrate (a “display glass”).

In recent years, some devices have been developed that use active illumination for touch/gesture sensing. Some types of optical touch-based and gesture-based user interfaces may involve the use of an optical stylus capable of providing active illumination to a light guide. Although existing optical styli are generally satisfactory, improved devices and methods would be desirable.

### SUMMARY

The systems, methods and devices of this disclosure each have several innovative aspects, no single one of which is solely responsible for the desirable attributes disclosed herein.

One innovative aspect of the subject matter described in this disclosure can be implemented in an optical stylus that includes a light source system, a light sensor system and a control system. The control system may be capable of receiving light sensor data from the light sensor system and determining an amount of optical stylus tilt according to the light sensor data. At least some of the light provided by the light source system may be collimated light.

The light sensor data may indicate changes in flux of light received by one or more optical sensors of the light sensor system. The control system may be capable of determining the amount of optical stylus tilt according to the changes in flux. In some examples, the light sensor data may indicate changes in a spatial distribution of flux of light received by the light sensor system. The control system may be capable of determining the amount of optical stylus tilt according to the changes in the spatial distribution of flux.

Some implementations may include a flux-modifying apparatus disposed between at least one light source of the light source system and at least one light sensor of the light sensor system. The flux-modifying apparatus may include a variable transmissivity apparatus having a transmissivity that may vary according to the amount of optical stylus tilt. For example, the variable transmissivity apparatus may include a reflective liquid, reflective particles, an absorptive liquid and/or absorptive particles.

Some implementations may include a reflector system having at least one mirror. Changes in the amount of optical stylus tilt may cause corresponding changes in flux of light reflected from the reflector system to the light sensor system.

Some implementations may include a deformable tip. For example, the deformable tip may include an internal partially reflective surface. The internal partially reflective surface may be capable of reflecting a portion of light from the light source system towards the light sensor system. A flux of light reflected from the internal partially reflective surface towards the light sensor system may vary according to the amount of optical stylus tilt. In some examples, a spatial distribution of flux of light received by the light sensor system may vary according to the amount of optical stylus tilt.

Some implementations may include a layer of light-absorbing material disposed on an inner surface of the optical stylus. A flux of light reflected from the internal partially reflective surface towards the light-absorbing material may vary according to the amount of optical stylus tilt. Some implementations may include an aperture that allows light from a light source of the light source system to be emitted from the optical stylus.

Another innovative aspect of the subject matter described in this disclosure can be implemented in a method that may involve receiving light sensor data from a plurality of light sensors of a light sensor system and determining an amount of optical stylus tilt according to the light sensor data. In some implementations, the light sensor data may indicate changes in flux of light received by one or more of the optical sensors and the determining process may involve determining the amount of tilt according to the changes in flux. In some examples, the light sensor data may indicate changes in a spatial distribution of flux of light received by the light sensor system and wherein the determining process may involve determining the amount of tilt according to the changes in the spatial distribution of flux.

Another innovative aspect of the subject matter described in this disclosure can be implemented in an optical stylus that includes a light source system, a light sensor system, a deformable tip and a control system. The control system may be capable of receiving light sensor data from the light sensor system and determining an amount of pressure applied to the optical stylus according to the light sensor data. In some implementations, the control system also may be capable of determining an amount of optical stylus tilt according to the light sensor data.

In some examples, the light sensor data may indicate changes in flux of light received by one or more optical sensors of the light sensor system. The control system may be capable of determining the amount of pressure applied to the optical stylus according to the changes in flux. At least some light provided by the light source system may be collimated light.

In some implementations, the deformable tip may include an internal partially reflective surface. For example, the internal partially reflective surface may be capable of reflecting a portion of light from the light source system towards the light sensor system. The amount of light reflected from the internal partially reflective surface towards the light sensor system may vary according to the amount of pressure applied to the optical stylus.

Some implementations may include an aperture that allows light from a light source of the light source system to be emitted from the optical stylus. For example, the internal partially reflective surface may be disposed between the light source and the aperture.

In some implementations, the deformable tip may include material having a high degree of transparency. For example, the amount of light reflected from the deformable tip may decrease with increasing pressure.

In some examples, the deformable tip may include a waveguide system. Some implementations may include a light source system capable of injecting light into the waveguide system. The waveguide system may be disposed within deformable walls of the deformable tip. The deformable walls may be capable of forming kinked portions when the deformable tip may be pressed against a surface. In some implementations, the kinked portions may be capable of coupling light from the waveguide system into an optically transmissive surface.

Another innovative aspect of the subject matter described in this disclosure can be implemented in a method that involves receiving light sensor data from a light sensor system and determining an amount of pressure applied to an optical stylus according to the light sensor data. The receiving process may involve receiving light sensor data from a plurality of light sensors disposed in the optical stylus. Alternatively, or additionally, the receiving process may involve receiving light sensor data from a plurality of light sensors disposed on the periphery of a waveguide to which the optical stylus is providing light. The determining process may involve determining changes in at least one of the intensity or distribution of light received from the optical stylus.

At least some of the methods disclosed herein may be implemented via software stored on one or more non-transitory media. For example, the processes of a method or algorithm disclosed herein may be implemented in a processor-executable software module which may reside on a non-transitory medium. By way of example, and not limitation, non-transitory media may include RAM, ROM, EEPROM, CD-ROM or other optical disk storage, magnetic disk storage or other magnetic storage devices, etc.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1A is a top view that shows examples of elements of an optical touch/proximity sensing apparatus.

FIG. 1B is a perspective diagram of an optical touch/proximity sensing apparatus similar to that shown in FIG. 1A.

FIG. 1C is a block diagram that includes examples of optical touch/proximity sensing apparatus elements.

FIG. 2 is a top view that shows example elements of an alternative optical touch/proximity sensing apparatus.

FIG. 3 is a block diagram that includes examples of optical stylus elements.

FIGS. 4A and 4B are cross-sectional diagrams of one example of an optical stylus having a variable transmissivity apparatus.

FIGS. 5A and 5B show examples of one arrangement of light sensors within a light sensor system of an optical stylus.

FIGS. 5C and 5D show examples of different light sensor data values for the same light sensor configuration shown in FIGS. 5A and 5B.

FIG. 5E shows an example of an alternative configuration of light sensors within an optical stylus.

FIG. 5F shows a cross-sectional view of another example of light sensors arranged within an optical stylus.

FIG. 6 is a block diagram that shows example elements of an alternative optical stylus.

FIGS. 7A and 7B show examples of an optical stylus that includes a variable refractivity apparatus.

FIG. 7C shows another example of a spatial distribution of flux that is symmetrical about the central axis of an optical stylus.

FIG. 7D is a top view of a light sensor system 310 of an optical stylus 120 that is oriented as shown in FIG. 7B.

FIG. 8 shows a cross-sectional view of an alternative example of an optical stylus.

FIG. 9 is a block diagram that shows example elements of an alternative optical stylus.

FIG. 10 shows an example of an optical stylus that includes a deformable tip with an internal partially reflective surface.

FIG. 11 shows an alternative example of an optical stylus that includes a deformable tip.

FIGS. 12A and 12B show an example of an alternative optical stylus configuration.

FIG. 13 is a block diagram that shows example elements of an alternative optical stylus.

FIGS. 14 and 15A show examples of an optical stylus having a waveguide in a deformable tip.

FIGS. 15B and 15C show alternative examples of optical styli that include a waveguide in a deformable tip.

FIG. 16 is a block diagram that outlines one implementation of a method of determining optical stylus tilt.

FIG. 17 is a block diagram that outlines one implementation of a method of determining an amount of pressure applied to an optical stylus.

FIGS. 18A and 18B show examples of system block diagrams illustrating a display device that includes a touch/proximity sensing apparatus as described herein.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

In some implementations, a touch/proximity sensing apparatus may include a light guide and light sensors disposed around one or more sides and/or corners of the light guide. Various implementations disclosed herein involve an optical stylus capable of providing active illumination for such a touch/proximity sensing apparatus. In some implementations, the optical stylus (and/or the touch/proximity sensing apparatus) may be capable of determining a tilt angle of the optical stylus and/or an amount of pressure exerted upon the optical stylus. In some examples, an optical stylus may determine a tilt angle and/or pressure according to changes in optical flux distributions inside the optical stylus. In some examples, an optical stylus may include a deformable tip. The deformable tip and/or associated features may be capable of altering optical flux distributions inside the optical stylus in response to applied pressure and/or optical stylus tilt. In some implementations, the optical flux provided by the optical stylus to a light guide of a touch/proximity sensing apparatus may vary according to pressure applied to the optical stylus.

Particular implementations of the subject matter described in this disclosure can be implemented to realize one or more of the following potential advantages. A deformable tip may provide a more pleasant tactile experience to a user, while providing information to an optical stylus control system upon which tilt and/or pressure determinations may be made. A light source system of the optical stylus may provide light not only for active illumination of a touch/proximity sensing apparatus, but also for tilt and/or pressure determination. Tilt and/or pressure information may be communicated from the optical stylus to other elements of the touch/proximity sensing apparatus, e.g., by optical input to the light guide, via a wireless interface, etc. In some examples, the touch/proximity sensing apparatus may adjust a position-determining process to correct for optical stylus tilt. In some implementations, the touch/proximity sensing apparatus may communicate pressure information to a user as, e.g., thicker line weight. Some implementations may potentially reduce cost by avoiding the need for separate pressure sensors and/or tilt sensors.

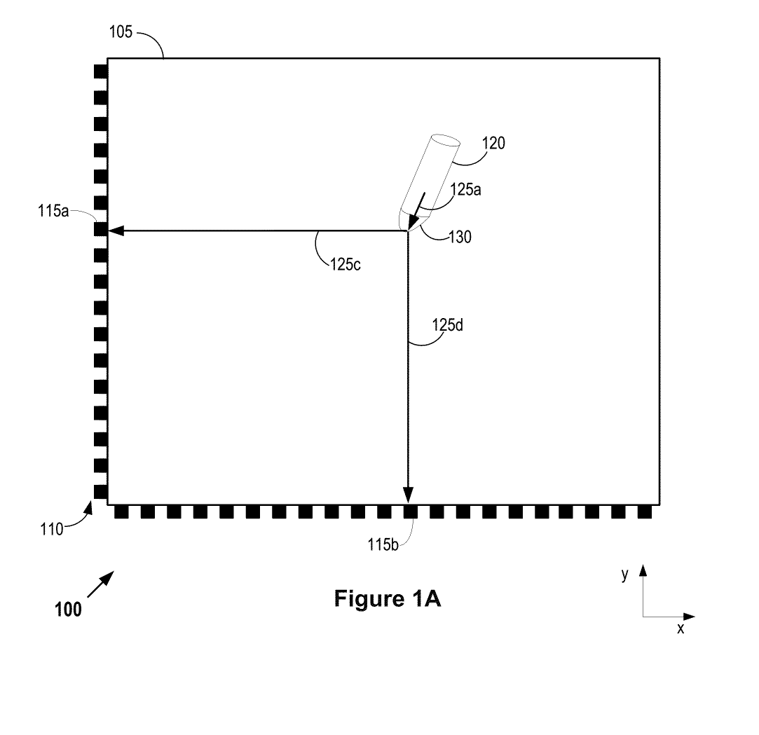

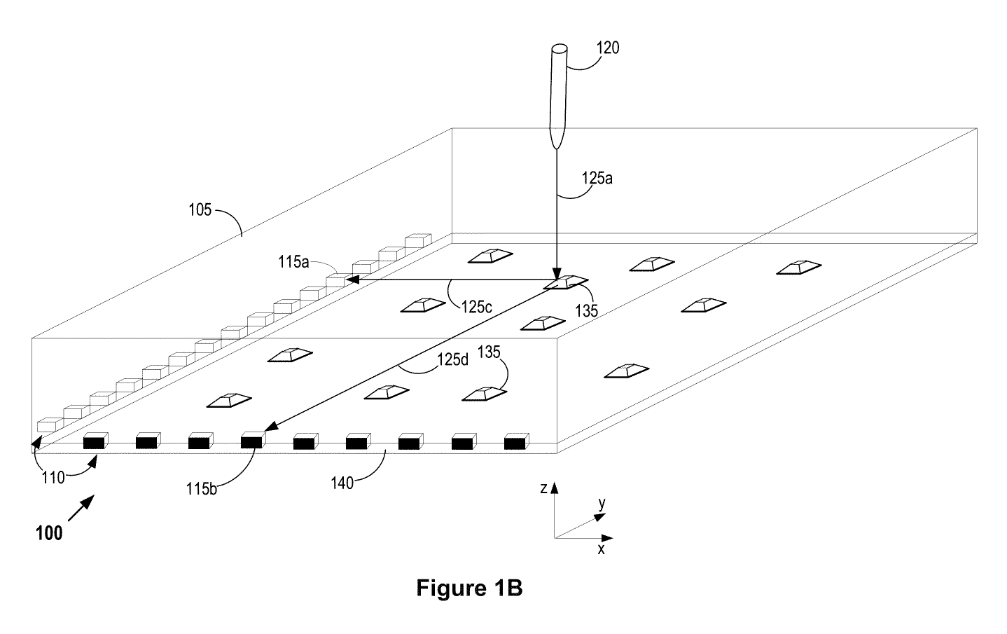

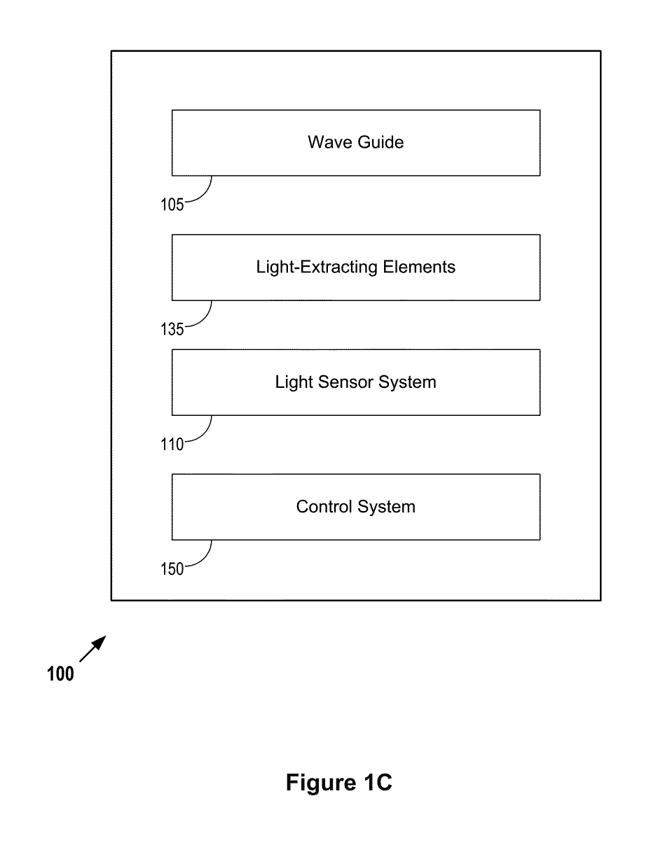

FIG. 1A is a top view that shows examples of elements of an optical touch/proximity sensing apparatus. In this implementation, the optical touch/proximity sensing apparatus 100 includes a light guide 105 and a light sensor system 110. In this example, the light sensor system 110 includes light sensors 115a disposed along (e.g., edge-coupled to) a first side of the light guide 105 and light sensors 115b disposed along a second side of the light guide 105. Other implementations may include light sensors 115 disposed along more or fewer sides of the light guide 105. The light sensors 115 may, for example, include photodiodes, such as silicon photodiodes. In some examples, the light sensors 115 may include a charge-coupled device (CCD) array, a complementary metal oxide semiconductor (CMOS) array, etc.

Some types of optical touch/proximity sensing apparatus may include a light source system optically coupled to one or more sides of the light guide 105. However, various implementations described herein are capable of providing optical touch/proximity sensing based, at least in part, on light received from an optical stylus. In FIG. 1A, for example, the optical stylus 120 is shown providing light 125a to the light guide 105. In some implementations, the optical stylus 120 may be capable of providing light in a wavelength range that is outside the visible spectrum, e.g., in the infrared range. The light sensor system 110 may, for example, be capable of passing and detecting light in the wavelength range and of filtering out light that is outside of the wavelength range.

In the example shown in FIG. 1A, the optical stylus 120 includes a deformable tip 130. For example, the deformable tip 130 may be formed of a polymer such as silicone. Various examples of deformable tips 130 are provided in this disclosure.

In this example, the optical touch/proximity sensing apparatus 100 is capable of determining a position of the optical stylus 120 based on the light 125a provided by the optical stylus 120. In this implementation, light-turning features of the light guide 105 (not shown in FIG. 1A) are capable of directing the light 125 in two substantially orthogonal directions: here, the light 125c is directed substantially along the x axis, towards one of the light sensors 115a and the light 125d is directed substantially along the y axis, towards one of the light sensors 115b. Accordingly, a control system of the optical touch/proximity sensing apparatus 100 may readily determine the x and y coordinates of the optical stylus 120, which would correspond to the x and y coordinates of the light sensors 115a and 115b in this example.

FIG. 1B is a perspective diagram of an optical touch/proximity sensing apparatus similar to that shown in FIG. 1A. In this example, optical touch/proximity sensing apparatus 100 includes a plurality of light-extracting elements 135. Here, the light-extracting elements 135 are capable of directing light in two substantially orthogonal directions. In this example, the optical stylus 120 is shown providing light substantially along the z axis. As in the example shown in FIG. 1A, the light 125c is directed substantially along the x axis, towards one of the light sensors 115a and the light 125d is directed substantially along the y axis, towards one of the light sensors 115b.

In the example shown in FIG. 1B, the light-extracting elements 135 are formed in a light-extracting layer 140, disposed on a surface of the light guide 105. However, in alternative implementations, the light-extracting elements 135 may be part of, and/or formed in, the light guide 105. In some other implementations, a light-extracting layer 140 may include diffraction gratings capable of light extraction. Such diffraction gratings may be physical diffraction gratings or holograms.

FIG. 1C is a block diagram that includes examples of optical touch/proximity sensing apparatus elements. In this example, the optical touch/proximity sensing apparatus 100 includes a wave guide 105, light-extracting elements 135, a light sensor system 110 and a control system 150. The control system 150 may be capable of receiving light sensor data from light sensors of the light sensor system 110. The light sensor data may correspond to light provided by an optical stylus, some of which may be directed by the light-extracting elements 135 towards corresponding optical sensors. The control system 150 may be capable of determining the location of the optical stylus 120 based on the light sensor data.

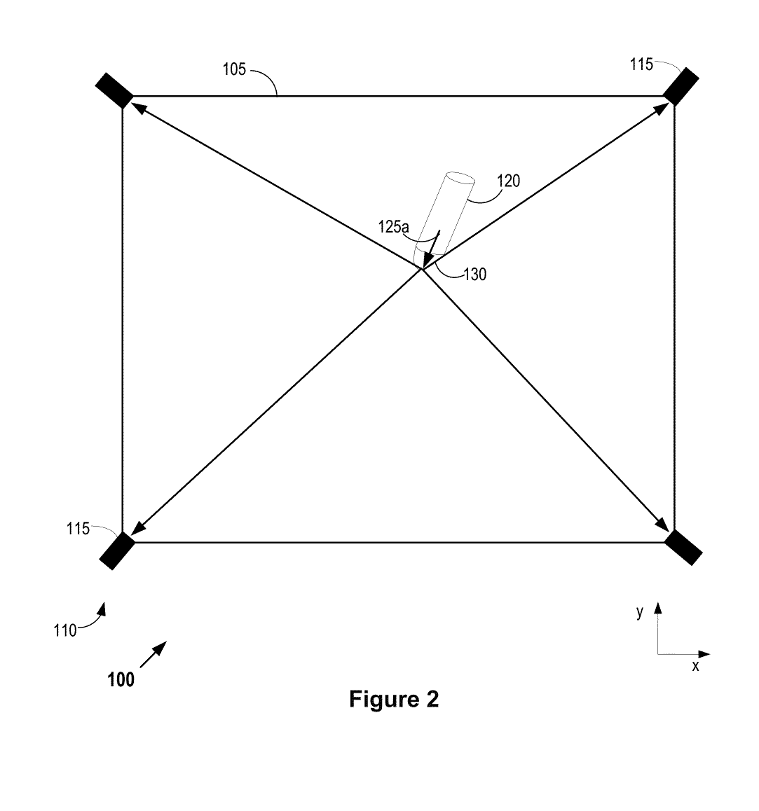

FIG. 2 is a top view that shows example elements of an alternative optical touch/proximity sensing apparatus. In this example, the optical touch/proximity sensing apparatus 100 includes a light sensor 115 at each of four corners. A portion of the light 125a provided by the optical stylus 120 may be detected by two, three or all four of the light sensors 115. In such implementations, a control system of the optical touch/proximity sensing apparatus 100 may determine the position of the optical stylus 120 according to the relative intensity of light received by each of the light sensors 115.

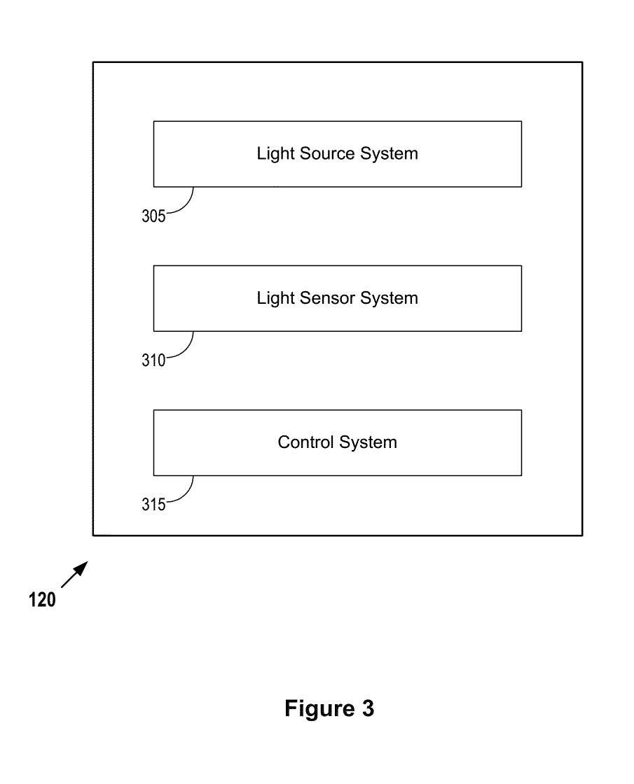

FIG. 3 is a block diagram that includes examples of optical stylus elements. In this example, the optical stylus 120 includes a light source system 305, a light sensor system 310 and a control system 315. The light source system 305 may include one or more of various types of light sources, according to the implementation. In some examples, the light source system 305 may include one or more light-emitting diodes (LEDs), laser diodes, vertical cavity surface-emitting lasers (VCSELs), etc. Accordingly, in some implementations the light source system 305 may be capable of providing collimated light.

The light sensors 115 may, for example, include photodiodes, such as silicon photodiodes. In some examples, the light sensors 115 may include a charge-coupled device (CCD) array, a complementary metal oxide semiconductor (CMOS) array, etc.

The control system 315 may be capable of controlling the light source system 305 to provide light to a light guide of an optical touch/proximity sensing apparatus. In some implementations, the control system 315 also may be capable of controlling the light source system 305 to provide light to the light sensor system 310. In various implementations shown and described herein, the flux of light received by light sensors of the light sensor system 310 may vary according to the tilt angle of the optical stylus 120.

The control system 315 may be capable of receiving light sensor data from the light sensor system 310 and of determining an amount of optical stylus tilt according to the light sensor data. In some implementations, the “amount of optical stylus tilt” may correspond with a tilt angle. In other implementations, the “amount of optical stylus tilt” may be measured and/or expressed in other ways, such as being within one of a plurality of angle ranges (e.g., within one of a series of five-degree ranges, ten-degree ranges, fifteen-degree ranges, twenty-degree ranges, twenty-five-degree ranges, thirty-degree ranges, thirty-five-degree ranges, forty-degree ranges, forty-five-degree ranges, etc.), within a range that includes an minimum and a maximum value (e.g., from zero to 10, zero to 20, zero to 50, zero to 100, zero to 200 zero to 300, zero to 400, zero to 500, zero to 1,000, etc.) or in some other manner. In some implementations, the light sensor data may indicate changes in flux of light received by one or more optical sensors of the light sensor system 310. The control system 315 may be capable of determining the amount of optical stylus tilt according to the changes in flux.

Alternatively, or additionally, the light sensor data may indicate changes in a spatial distribution of flux of light received by the light sensor system. The control system 315 may be capable of determining the amount of optical stylus tilt according to the changes in the spatial distribution of flux.

In some implementations, the control system 315 may be capable of determining the amount of optical stylus tilt by reference to stored light sensor data. Instances of the stored light sensor data may correspond to optical stylus tilt angles. For example, an instance of stored light sensor data may correspond to responses from each of a plurality of light sensors when the optical stylus was positioned at a corresponding tilt angle. Taken collectively, these responses provide one example of “a spatial distribution of flux.” In some implementations, for example, the control system 315 may be capable of determining the amount of optical stylus tilt by comparing a current spatial distribution of flux with stored spatial distributions of flux, each of which corresponds to an optical stylus tilt angle. The control system 315 may, for example, be capable of determining which of the stored spatial distributions of flux is most similar to the current spatial distribution of flux. Various examples are provided below.

The control system 315 may include one or more general purpose single- or multi-chip processors, digital signal processors (DSPs), application specific integrated circuits (ASICs), field programmable gate arrays (FPGAs) or other programmable logic devices, discrete gates or transistor logic, discrete hardware components, or combinations thereof. The control system 315 also may include (and/or be configured for communication with) one or more memory devices, such as one or more random access memory (RAM) devices, read-only memory (ROM) devices, etc.

In some implementations, for example, the control system 315 may be capable of communicating data indicating the orientation of the optical stylus 120 to the optical touch/proximity sensing apparatus 100 by modulating the amplitude and/or wavelength of the light 125a that is provided to the light guide 105. Alternatively, or additionally, the control system 315 may be capable of communicating data indicating the orientation of the optical stylus 120 to the optical touch/proximity sensing apparatus 100 or to another device via a wireless interface, and/or another device interface.

In some implementations, the optical stylus 120 may include a flux-modifying apparatus disposed between at least one light source of the light source system and at least one light sensor of the light sensor system. For example, in some implementations the optical stylus 120 may include a variable transmissivity apparatus disposed between at least one light source of the light source system and at least one light sensor of the light sensor system. The variable transmissivity apparatus may have a transmissivity that varies according to the amount of optical stylus tilt. Alternatively, the flux-modifying apparatus may include a variable refractivity apparatus. Various examples are provided below.

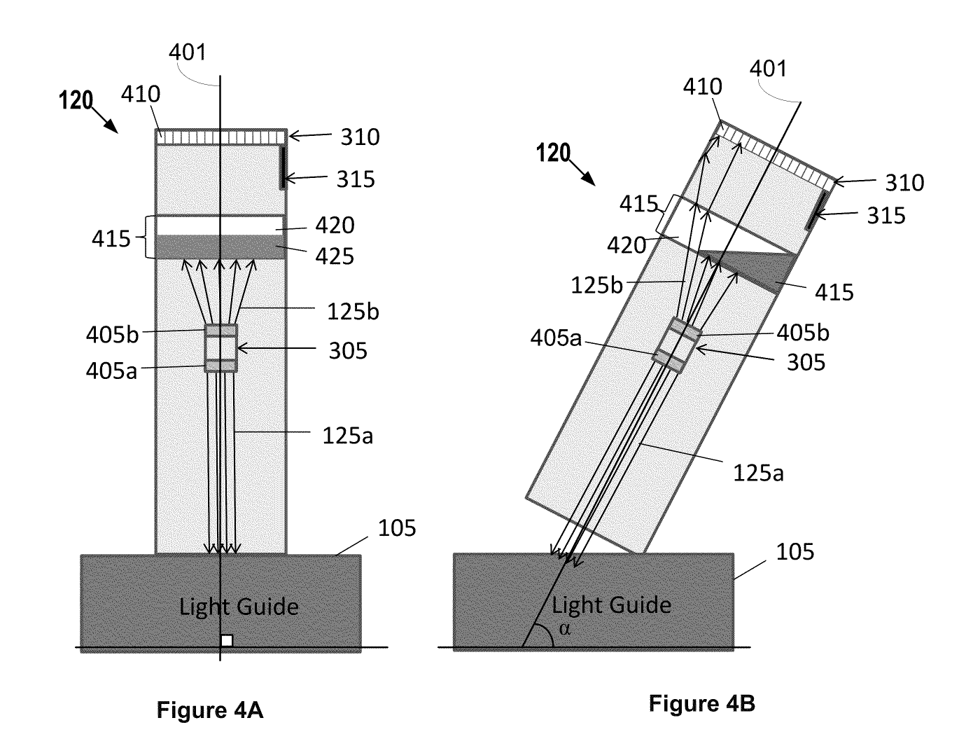

FIGS. 4A and 4B are cross-sectional diagrams of one example of an optical stylus having a variable transmissivity apparatus. In FIG. 4A, the optical stylus 120 is shown in an orientation in which an axis 401 of the optical stylus 120 is substantially normal to a plane of the light guide 105. In FIG. 4B, the same optical stylus 120 is shown in an orientation in which the axis 401 is at an angle α to the plane of the light guide 105.

In these examples, the optical stylus 120 includes a light source system 305 that includes light source elements 405a and 405b. Light source element 405a includes one or more light sources capable of directing light 125a outside of the optical stylus 120, e.g., to the light guide 105. Light source element 405b includes one or more light sources capable of directing light 125b towards the light sensor system 310, which includes an array of light sensors 410 in this example.

A control system 315 is also depicted in FIGS. 4A and 4B. The control system 315 may be capable of controlling the light source system 305. In these examples, the control system 315 is capable of receiving light sensor data from the light sensor system 310 and of determining an amount of optical stylus tilt according to the light sensor data.

In some implementations, the control system 315 may be capable of communicating data indicating the orientation of the optical stylus 120, including but not necessarily limited to optical stylus tilt data, to a user and/or to an optical touch/proximity sensing apparatus 100. In some implementations, the control system 315 may be capable of communicating such data to a user via a display (e.g., by controlling the display to indicate a tilt angle of the optical stylus 120). In some implementations, for example, the control system 315 may be capable of communicating data indicating the orientation of the optical stylus 120 by modulating the amplitude and/or wavelength of the light 125a that is provided to the light guide 105. Alternatively, or additionally, the control system 315 may be capable of communicating data indicating the orientation of the optical stylus 120 via a wireless interface, and/or another device interface.

As noted above, the optical touch/proximity sensing apparatus 100 may determine the location of the optical stylus 120 according to the position at which the light 125a is provided to the light guide. As shown in FIG. 4B, the position at which the light 125a is provided to the light guide will vary according to the cosine of the tilt angle. In some implementations, the optical touch/proximity sensing apparatus 100 may be capable of adjusting a process of determining the optical stylus position by taking into account optical stylus orientation and tilt angle information.

In the examples shown in FIGS. 4A and 4B, the optical stylus 120 includes a flux-modifying apparatus, which is a variable transmissivity apparatus 415 in this example. In this implementation, the variable transmissivity apparatus 415 includes an enclosure containing an absorptive liquid 425 and a gas 420. The absorptive liquid 425 may, for example, include ink, dye, etc. In alternative implementations, the variable transmissivity apparatus 415 may include a reflective liquid (such as mercury), reflective particles (such as reflective metal particles) or absorptive particles, e.g., metal oxides or inorganic pigments, such as TiO₂.

Here, the variable transmissivity apparatus 415 has a transmissivity that varies according to the amount of optical stylus tilt. In the example shown in FIG. 4A, when the axis 401 of the optical stylus 120 is substantially normal to the plane of the light guide 105, the absorptive liquid 425 absorbs most of the light 125b provided by the light source element 405a.

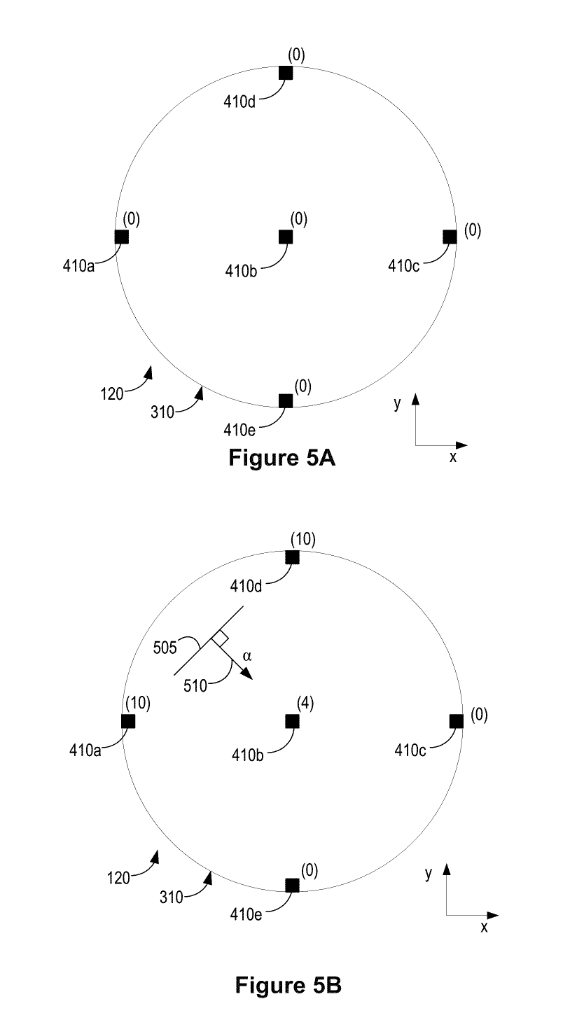

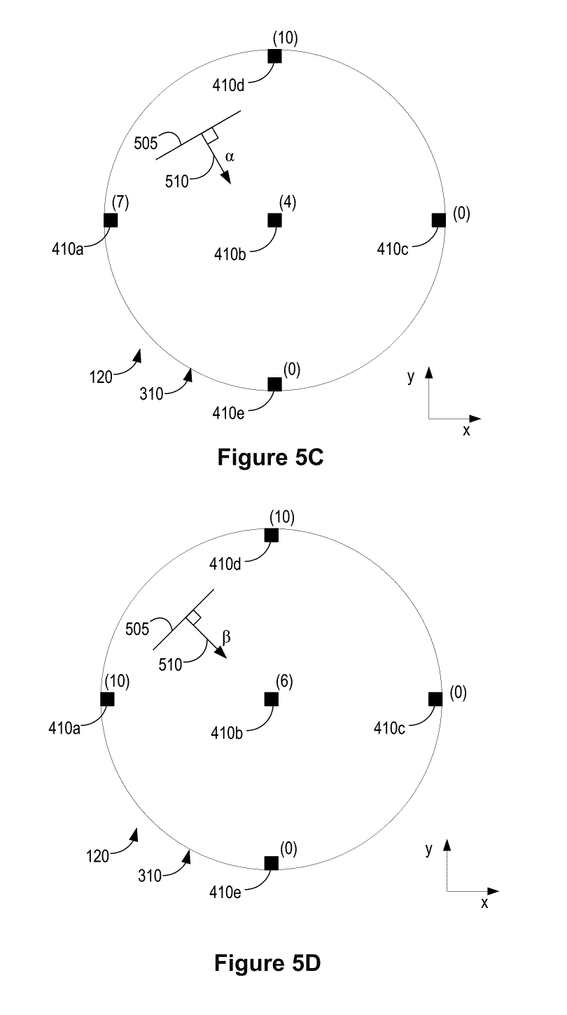

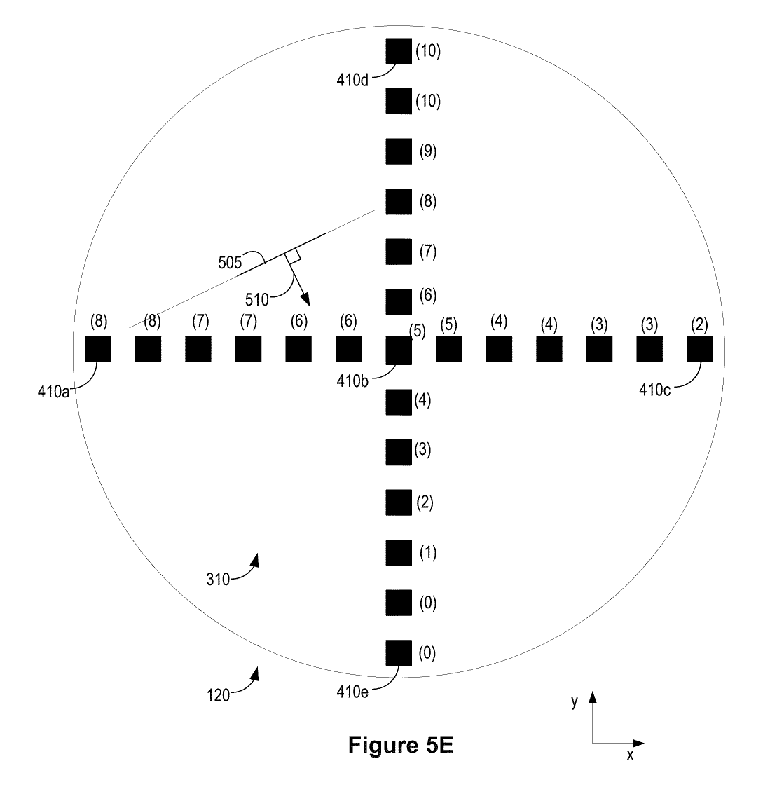

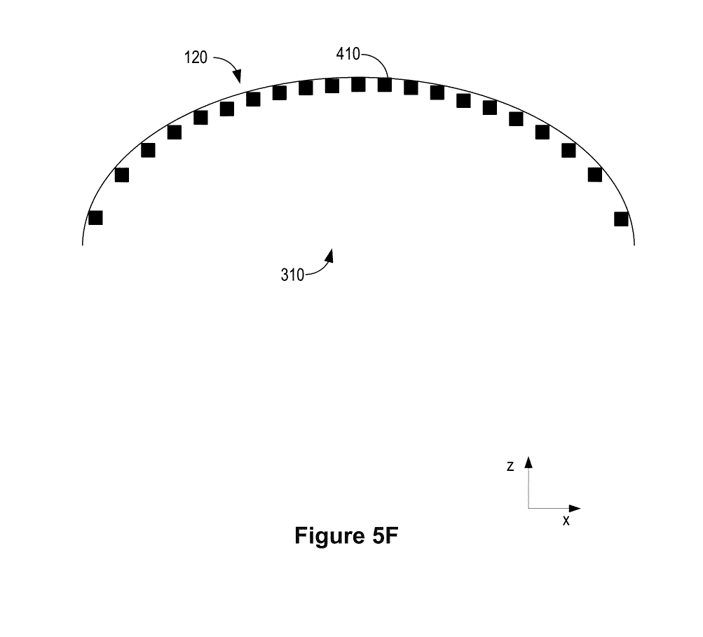

FIGS. 5A and 5B show examples of one arrangement of light sensors within a light sensor system of an optical stylus. FIGS. 5A and 5B also show examples of light sensor data for each of the light sensors 410. In these and other examples of light sensor data provided herein, the light sensor data can vary from a minimum of zero to a maximum of 10. However, this range of values is merely a convenient example, made for the purpose of illustration.

The light sensor data values shown in FIG. 5A correspond to the orientation of the optical stylus 120 that is shown in FIG. 4A. In this orientation, the absorptive liquid 425 prevents substantially all of the light 125b from reaching the light sensor system 310. Therefore, the light sensor data values shown in FIG. 5A are all zero.

In the example shown in FIG. 5B, the light sensor data values correspond to the orientation of the optical stylus 120 that is shown in FIG. 4B. In this example, with the optical stylus positioned at a tilt angle of a degrees relative to the plane of the light guide, the absorptive liquid 425 has flowed towards the lower, right side of the variable transmissivity apparatus 415. In the upper side of the variable transmissivity apparatus 415, there is no absorptive liquid 425 to block the light 125b from reaching the light sensors 410a and 410d. At a tilt angle of a degrees, relatively less of the absorptive liquid 425 is disposed between the light source element 405a and the light sensor 410b. In this example, the absorption coefficient of the absorptive liquid 425 has been selected such that at least some of the light 125b can reach the light sensor 410b: in this simplified example, about 40% of the light 125b is transmitted through this portion of the variable transmissivity apparatus 415, resulting in a light sensor data value of 4.

Based on the light sensor data values shown in FIG. 5B, the control system 315 has determined that the tilt angle is a degrees. The orientation of the optical stylus 120, as determined by the control system 315, is shown by the axis 505 and the dip vector 510. In this example, the orientation of the axis 505 and the dip vector 510 corresponds with the pattern of light sensor data values shown in FIG. 5B. The control system 315 may, for example, apply a contouring algorithm to determine the orientation of the axis 505 and the dip vector 510. Alternatively, or additionally, the control system 315 may determine the orientation and the magnitude of the dip vector 510 by computing gradients between the light sensor data values shown in FIG. 5B.

In some implementations, however, the control system 315 may determine the orientation and the magnitude of the dip vector 510 by comparing a current pattern of light sensor data values with stored patterns of light sensor data values. Each of the stored patterns of light sensor data values may, for example, correspond with an optical stylus tilt angle.

FIGS. 5C and 5D show examples of different light sensor data values for the same light sensor configuration shown in FIGS. 5A and 5B. In these examples, the light sensor data values are for the same optical stylus 120 shown in FIGS. 4A and 4B, but with the optical stylus 120 in different orientations.

In the example shown in FIG. 5C, all of the light sensor data values are the same as those shown in FIG. 5B, except that the light sensor data value for the light sensor 410a is 7 instead of 10. The decreased light sensor data value indicates that less light 125b is reaching the light sensor 410a, indicating that relatively more of the absorptive liquid 425 is disposed between the light source element 405a and the light sensor 410a in this example. In this example, the control system 315 has determined that the tilt angle is a degrees, but that the orientation of the dip vector 510 (and therefore of the axis 510) differs slightly from that shown in FIG. 5B.

In the example shown in FIG. 5D, all of the light sensor data values are the same as those shown in FIG. 5B, except that the light sensor data value for the light sensor 410b is 6 instead of 4. The increased light sensor data value indicates that more light 125b is reaching the light sensor 410b, indicating that relatively less of the absorptive liquid 425 is disposed between the light source element 405a and the light sensor 410b in this example. Therefore, in this example the control system 315 has determined that the tilt angle is β degrees, a value greater than a degrees, but that the orientation of the dip vector 510 (and therefore of the axis 510) is substantially the same as that shown in FIG. 5B.

For implementations such as those shown in FIGS. 5A-5D, which have only a few light sensors 410, optical stylus tilt determinations may be based on light sensor data values of only a few light sensors. In some instances, optical stylus tilt determinations may be based on light sensor data values from a single light sensor. Some implementations of the optical stylus 120 may include more or fewer light sensors 410 than are shown in FIGS. 5A-5D. For example, one alternative implementation includes only 3 light sensors 410, spaced approximately 120 degrees apart along the outer edge of the light sensor system 310. Implementations having only a few light sensors 410 have the advantage that optical stylus tilt determinations may be based on relatively simple calculations and/or the comparison of relatively simple data structures. However, it will be appreciated that more accurate optical stylus tilt determinations may be made by light sensor systems 310 that include more light sensors.

FIG. 5E shows an example of an alternative configuration of light sensors within an optical stylus. In this example, the light sensor system 310 includes light sensors 410a-410e, in the positions shown in FIGS. 5A-5D. In addition, the light sensor system 310 of this optical stylus 120 includes 10 more optical sensors 410 along the x axis and 10 more optical sensors 410 along the y axis. The additional light sensors 410 provide additional light sensor data values for determining the orientation of the optical stylus 120, potentially resulting in more accurate determinations of optical stylus orientation. Other implementations may include more or fewer optical sensors 410. In some alternative implementations, at least some of the optical sensors 410 are not necessarily positioned along the x and y axes.

FIG. 5F shows a cross-sectional view of another example of light sensors arranged within an optical stylus. In this example, the top of the optical stylus 120 is curved, not flat. In this example, the light sensor system 310 includes an array of light sensors 410 that have a substantially equal spacing along the x axis, but which conform to the curvature of the optical stylus 120. Although only one array of light sensors 410 is shown in FIG. 5F, the light sensor system 310 may include 2 or more arrays of light sensors 410.

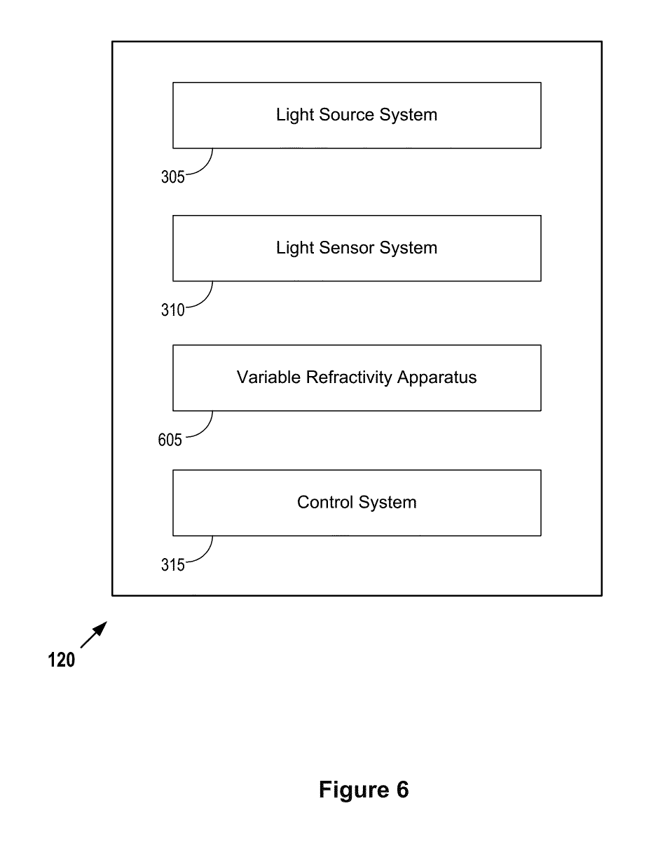

Various alternative examples of optical styli are disclosed herein. FIG. 6 is a block diagram that shows example elements of an alternative optical stylus. In this implementation, the optical stylus 120 includes a light source system 305, a light sensor system 310 and a control system 315. However, the implementation in FIG. 6 includes a different type of flux-modifying apparatus than that described with reference to FIGS. 4A and 4B. In this example, the flux-modifying apparatus is a variable refractivity apparatus 605 that is disposed between at least one light source of the light source system and at least one light sensor of the light sensor system.

In this example, the control system 315 is capable of receiving light sensor data from the light sensor system 310. Here, the light sensor data indicates responses of light sensors 410 to light transmitted through the variable refractivity apparatus 605. In this implementation, the control system 315 is capable of determining an amount of optical stylus tilt according to the light sensor data. In some instances, the light sensor data may indicate changes in a spatial distribution of flux of light received by the light sensor system. In some implementations, the variable refractivity apparatus 605 may include an enclosure containing a liquid and a gas. The changes in the spatial distribution of flux may be caused, at least in part, by changes in refraction angles of light transmitted through the liquid. The changes in refraction angles may be caused by changes of the distribution of the liquid within the variable refractivity apparatus 605.

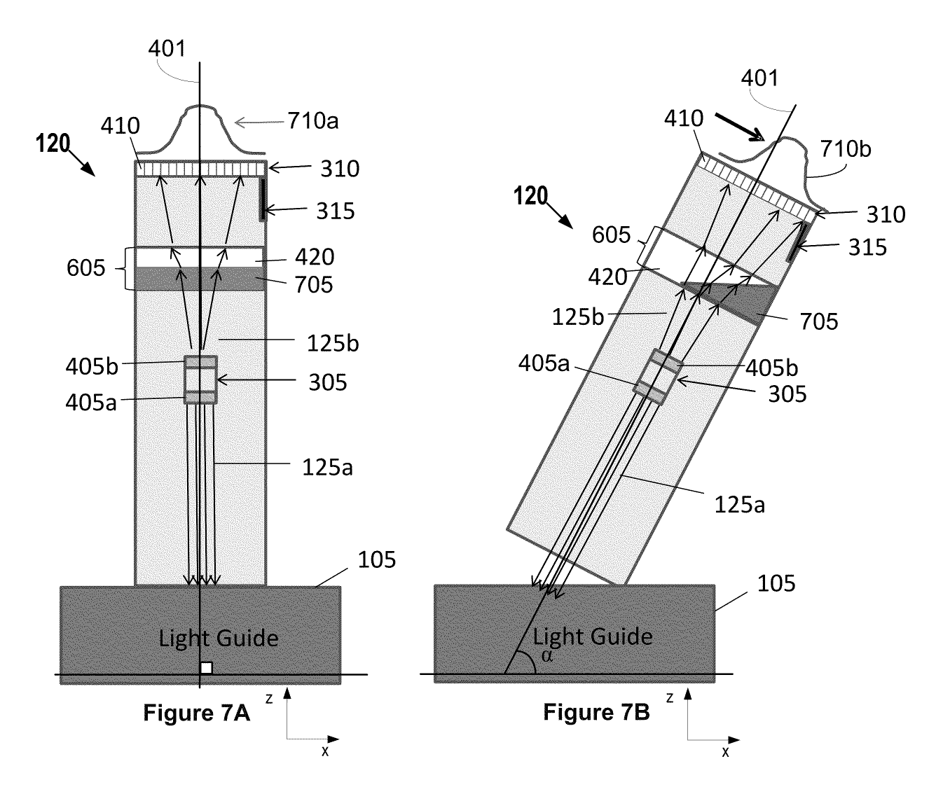

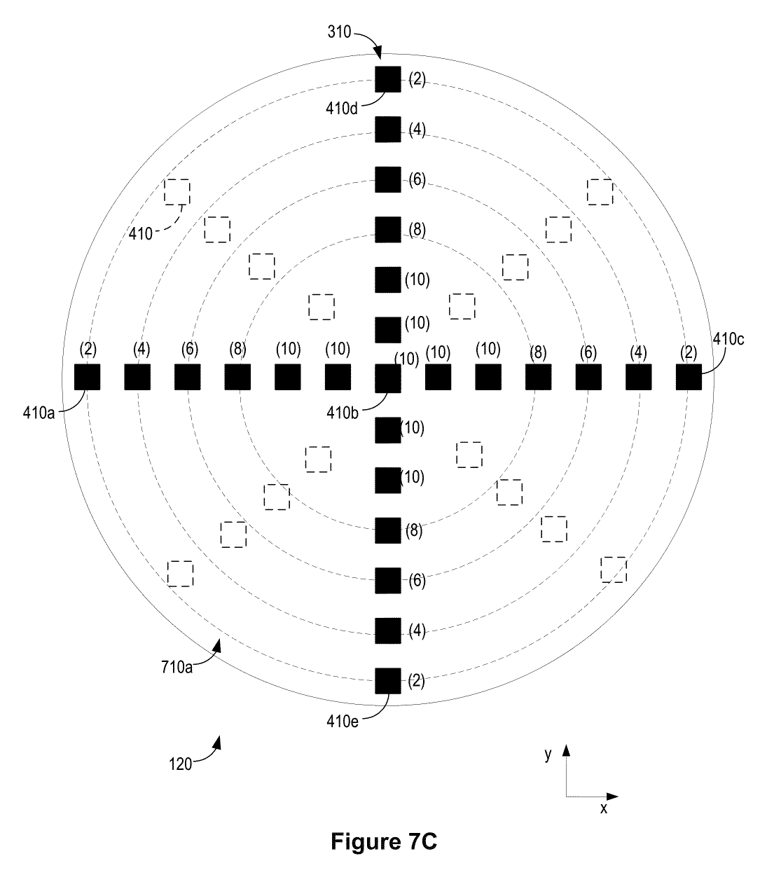

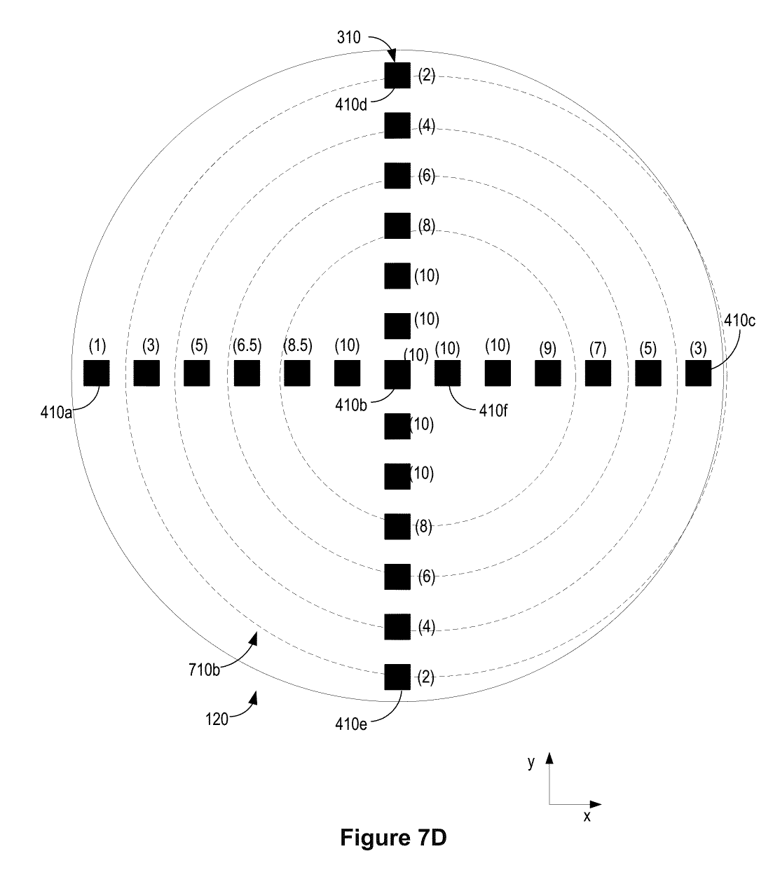

FIGS. 7A and 7B show examples of an optical stylus that includes a variable refractivity apparatus. In this example, the variable refractivity apparatus 605 includes a transmissive liquid 705 and a gas 420 within an enclosure. The transmissive liquid 705 may, for example, be water or oil. In this example, the axis 401 is a central axis of the optical stylus 120. When the axis 401 of the optical stylus 120 is substantially normal to the plane of the light guide 105, as shown in FIG. 7A, the resulting spatial distribution of flux 710a measured by the light sensor system 310 is symmetrical about the central axis.

FIG. 7C shows another example of a spatial distribution of flux that is symmetrical about the central axis of an optical stylus. FIG. 7C is a top view of a light sensor system 310 of an optical stylus 120 that is oriented as shown in FIG. 7A. As with other examples shown and described herein, FIG. 7C depicts light sensor data ranging from a minimum of zero to a maximum of 10. In this example, the spatial distribution of flux 710a is indicated by contour lines of light sensor data, each of which represents a 2-unit interval of light sensor data. In FIG. 7C, the spatial distribution of flux 710a is symmetrical and is centered around the location of the light sensor 410b, which coincides with the central axis of the optical stylus 120. In alternative implementations, the spatial distribution of flux 710a may be more precisely determined by including more light sensors 410 in the light sensor system 310, such as the optional light sensors 410 shown in dashed outlines.

In FIG. 7B, the optical stylus 120 of FIG. 7A is shown with the axis 401 tilted at an angle of α degrees relative to the plane of the light guide 105. The tilt angle causes the transmissive liquid 705 to flow towards the lower side of the optical stylus 120. This configuration causes a the light 125b to be refracted through a wedge-shaped volume of the transmissive liquid 705, causing changes in the refraction angles of light transmitted through the transmissive liquid 705. Here, the resulting spatial distribution of flux 710b has a peak that is shifted towards the lower side of the optical stylus 120, as compared to the spatial distribution of flux 710a.

FIG. 7D is a top view of a light sensor system 310 of an optical stylus 120 that is oriented as shown in FIG. 7B. In this example, the spatial distribution of flux 710b is indicated by contour lines of light sensor data, each of which represents a 2-unit interval of light sensor data. In FIG. 7D, the center of the spatial distribution of flux 710b has shifted from the location of the light sensor 410b towards the location of the light sensor 410f.

The control system 315 may be capable of determining the orientation of the optical stylus 120, including but not limited to an amount of optical stylus tilt, according to the spatial distribution of flux 710b. As shown in FIGS. 7C, 7D and elsewhere herein, spatial distributions of flux may be determined according to corresponding patterns of light sensor responses. Therefore, in some implementations, the control system 315 may determine the amount of optical stylus tilt by accessing a data structure that includes stored light sensor response patterns and corresponding optical stylus tilt amounts. The “tilt amounts” may, for example, be tilt angles, angle ranges, etc. The control system 315 may be capable of comparing a current pattern of light sensor responses with the stored light sensor response patterns.

In alternative implementations, the control system 315 may be capable of determining the orientation of the optical stylus 120, including but not limited to the amount of optical stylus tilt, without reference to stored light sensor patterns. For example, the control system 315 may be capable of determining the central location of the current spatial distribution of flux and of determining the amount and direction of offset relative to the central axis of the optical stylus 120. The control system 315 may be capable of determining an amount and direction of optical stylus tilt based on this offset. In some such implementations, the control system 315 may be capable of accessing a data structure of offset amounts and corresponding optical stylus tilt amounts. The control system 315 may be capable of matching a current offset amount with a stored offset amount to determine a corresponding optical stylus tilt amount.

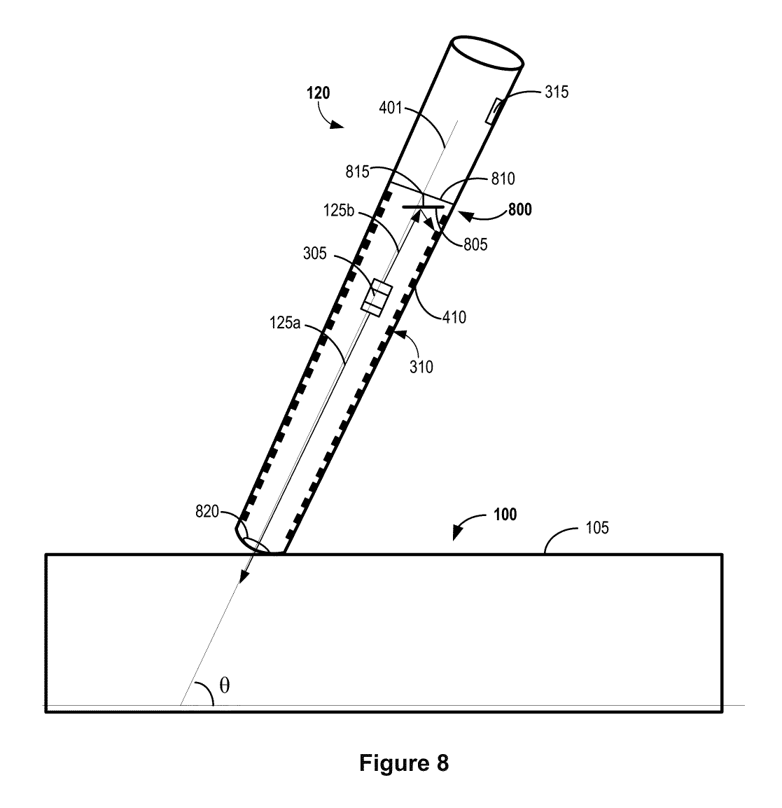

FIG. 8 shows a cross-sectional view of an alternative example of an optical stylus. In this example, the optical stylus 120 includes a light sensor system 310 having arrays of light sensors 410 arranged along interior walls of the optical stylus 120. Here, the optical stylus 120 includes a reflector system 800. In this implementation, changes in the amount of optical stylus tilt can cause corresponding changes in the flux of light reflected from the reflector system 800 to the light sensor system 310. In this example, the reflector system 800 includes a mirror 805 suspended by a frame 810 via a pivot 815. The light source system 305 is capable of directing light 125b towards the mirror 805. Here, the mirror 805 is allowed to rotate freely about the pivot 815 in order to maintain substantially the same orientation, even when the orientation of the optical stylus 120 is changing. Other implementations of the reflector system 800 may include additional mirrors 805 and/or different apparatus for suspending the mirror(s) 805.

In the example shown in FIG. 8, the axis 401 of the optical stylus 120 is oriented at a tilt angle of θ degrees relative to a plane of the light guide 105. However, in this implementation the plane of the mirror 805 remains substantially parallel to the plane of the light guide 105, even when the optical stylus 120 is moved through a wide range of tilt angles. A change in optical stylus tilt will cause light 125b to be detected by different light sensors 410 of the light sensor system 310. In this example, the control system 315 is capable of determining an amount and direction of optical stylus tilt based on which optical sensor(s) 410 are receiving light 125b reflected from the mirror 805.

As with other implementations, the optical stylus 120 may be capable of communicating optical stylus orientation information, including but not limited to tilt angle information, to the optical touch/proximity sensing apparatus 100. Such optical stylus orientation information may, for example, be communicated by modulating the light 125a provided by the light source system 305 according to control signals from the control system 315. Alternatively, or additionally, the control system 315 may be capable of communicating data indicating the orientation of the optical stylus 120 via a wireless interface, and/or another device interface.

In this example, aperture 820 allows light 125a to be emitted from the optical stylus 120 towards the optical touch/proximity sensing apparatus 100. Although only two arrays of light sensors 410 are shown in FIG. 8, the optical stylus 120 may include 3 or more such arrays, in order to allow an accurate determination of the orientation of the optical stylus 120.

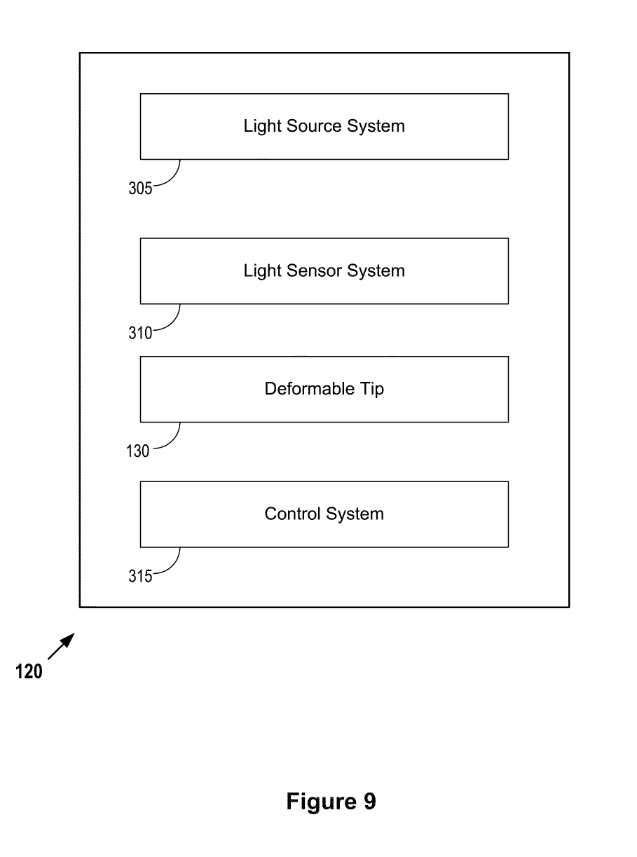

FIG. 9 is a block diagram that shows example elements of an alternative optical stylus. In this example, the optical stylus 120 includes a light source system 305, a light sensor system 310, a deformable tip 130 and a control system 315. In some implementations, the light source system 305 may be capable of producing collimated light. In this example, the control system 315 is capable of receiving light sensor data from the light sensor system and determining an amount of optical stylus tilt according to the light sensor data.

Various types of deformable tip 130 are disclosed herein. In some implementations, the deformable tip 130 may include an internal partially reflective surface capable of reflecting a portion of light from the light source system towards light sensors of the light sensor system.

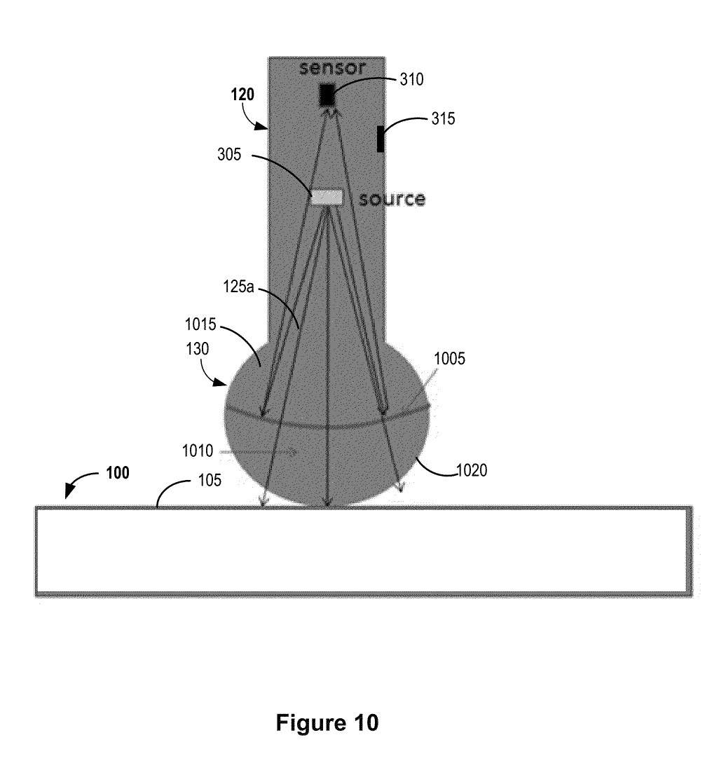

FIG. 10 shows an example of an optical stylus that includes a deformable tip with an internal partially reflective surface. In this example, the internal partially reflective surface 1005 allows some of the light 125a from the light source system 305 to be transmitted through the material 1010 and to the light guide 105. In some implementations, the material 1010 may include a solid, such as an elastomer, a gel (e.g., a polymer gel such as silicone) or a liquid, such as oil. According to some such implementations, the internal partially reflective surface 1005 may be an interface between the material 1010 and the material 1015, which may include a solid, a gel, a liquid or a gas. In some implementations, the material 1015 may include air.

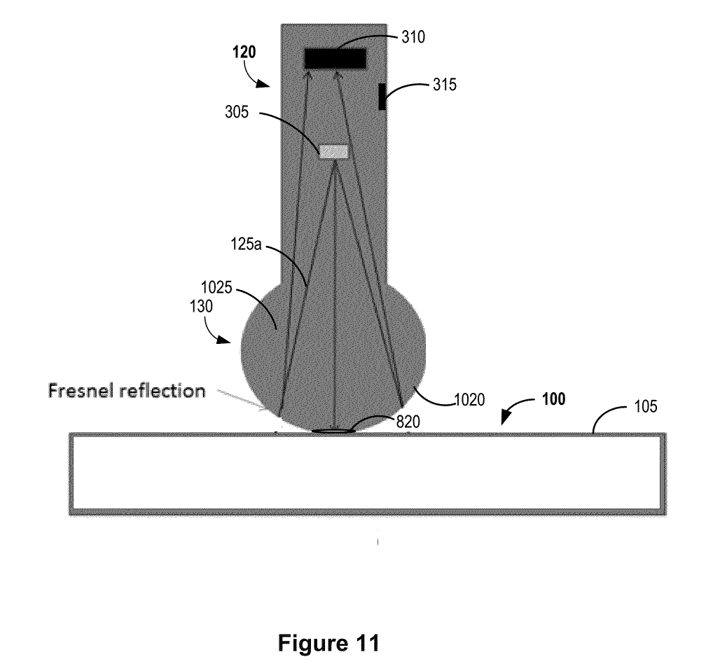

The outer surface 1020 may be formed of a flexible material, such as silicon, an elastomer, etc. The outer surface 1020 may be transparent or substantially transparent. In this example, at least some of the light 125a may be transmitted through the deformable tip 130 and through the air to the light guide 105. In alternative implementations (e.g. as described below with reference to FIG. 11), a substantial amount of the light 125a may be reflected from the air/deformable tip 130 interface. In some such implementations, a portion of the deformable tip 130 that is in contact with the light guide 105 may transmit substantially more light 125a, as compared to the flux of light 125a transmitted through the air/deformable tip 130 interface. The portion of the deformable tip 130 that is in contact with the light guide 105 may function as an aperture that allows light from the light source system 305 to be emitted from the optical stylus 120. In such configurations, the internal partially reflective surface 1005 may be disposed between the light source and the aperture.

Here, the internal partially reflective surface 1005 reflects some of the light 125a. A portion of the reflected light 125a may reach the light sensor system 310. The flux of reflected light 125a that reaches the light sensor system 310 may depend, at least in part, on the optical stylus tilt.

In this example, the control system 315 is capable of receiving light sensor data from the light sensor system 310 and determining an amount of optical stylus tilt according to the light sensor data. The light sensor data may indicate changes in flux of light received by one or more optical sensors of the light sensor system 310. The control system 315 may be capable of determining the amount of optical stylus tilt according to the changes in flux. Alternatively, or additionally, the light sensor data may indicate changes in a spatial distribution of flux of light received by the light sensor system 310. The control system 315 may be capable of determining the amount of optical stylus tilt according to the changes in the spatial distribution of flux.

The flux of reflected light 125a that reaches the light sensor system 310 may depend, at least in part, on the amount of pressure applied to the optical stylus 120. For example, in some implementations the internal partially reflective surface 1005 may deform in a predictable manner that corresponds to changes in pressure. This deformation may cause corresponding changes in the spatial distribution of light 125a that is reflected from the internal partially reflective surface 1005 and received by the light sensor system 310. In some implementations, the control system 315 may be capable of determining an amount of pressure applied to the optical stylus 120 according to corresponding light sensor data. In some implementations, the light sensor data may indicate changes in flux of light received by one or more optical sensors of the light sensor system 310. The control system 315 may be capable of determining the amount of pressure applied to the optical stylus 120 according to the changes in flux. Alternatively, or additionally, the light sensor data may indicate changes in a spatial distribution of flux of light received by the light sensor system 310. The control system 315 may be capable of determining the amount of pressure applied to the optical stylus 120 according to the changes in the spatial distribution of flux.

FIG. 11 shows an alternative example of an optical stylus that includes a deformable tip. In this implementation, the deformable tip 130 does not include an internal partially reflective surface. In this example, the deformable tip 130 includes material having a high degree of transparency. In some such implementations, the outer surface 1020 and the inner material 1025 may both have a high degree of transparency. The inner material 1025 may include a transparent or substantially transparent solid, as a transparent elastomer, a transparent or substantially transparent gel (e.g., a transparent polymer gel such as silicone), a liquid, such as oil, or a gas.

In the example shown in FIG. 11, a substantial amount of the light 125a may be reflected from the air/deformable tip 130 interface. For example, a substantial amount of the light 125a may be reflected from the interface between the outer surface 1020 and the outer air. In some such implementations, a portion of the deformable tip 130 that is in contact with the light guide 105 may transmit substantially more light 125a, as compared to the flux of light 125a transmitted through the air/deformable tip 130 interface. The portion of the deformable tip 130 that is in contact with the light guide 105 may function as an aperture 820 that allows light from the light source system 305 to be emitted from the optical stylus 120. As increased pressure is applied to the optical stylus 120, the size of the aperture 820 may increase. In such implementations, the flux of light 125a provided to the light guide 105 increases, and the flux of light 125a reflected from the deformable tip decreases, as increasing pressure is applied to the optical stylus 120.

Accordingly, the flux of reflected light 125a that reaches the light sensor system 310 may depend, at least in part, on the amount of pressure applied to the optical stylus 120. In some implementations, the control system 315 may be capable of determining an amount of pressure applied to the optical stylus 120 according to light sensor data received from the light sensor system 310. In some implementations, the light sensor data may indicate changes in flux of light received by one or more optical sensors of the light sensor system 310. The control system 315 may be capable of determining changes in the pressure applied to the optical stylus 120 according to the changes in flux. Alternatively, or additionally, the light sensor data may indicate changes in a spatial distribution of flux of light received by the light sensor system 310. The control system 315 may be capable of determining changes in the pressure applied to the optical stylus 120 according to the changes in the spatial distribution of flux.

In alternative implementations, the optical stylus 120 may not include a light sensor system 310. In some such implementations, a light sensor system of the optical touch/proximity sensing apparatus 100 (e.g., a light sensor system 110 such as that shown in any of FIGS. 1A-2) may be capable of detecting changes in the flux of light 125a provided to the light guide 105 caused by changes in the pressure applied to the optical stylus 120. For implementations of the optical stylus 120 such as that shown in FIG. 11, the flux of light 125a provided to the light guide 105 increases as increasing pressure is applied to the optical stylus 120. A control system of the optical touch/proximity sensing apparatus 100 (such as the control system 150 shown in FIG. 1C and described above) may be capable of receiving light sensor data from the light sensor system corresponding to the changes in the flux of light 125a provided to the light guide 105. The control system may be capable of determining changes in the pressure applied to the optical stylus 120 according to the light sensor data.

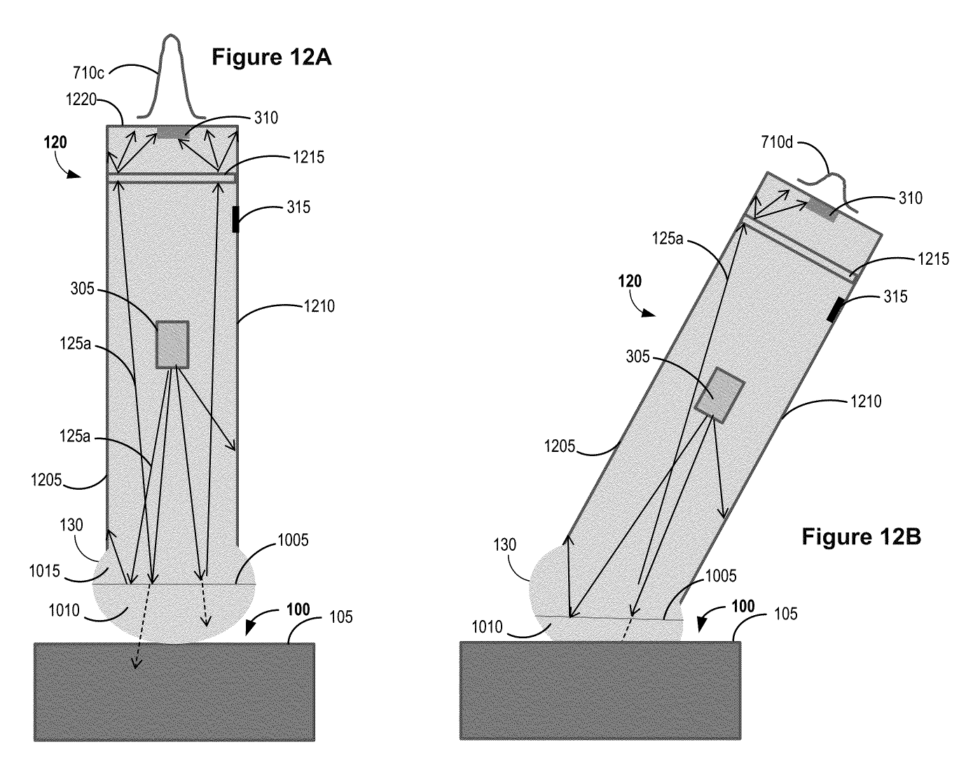

FIGS. 12A and 12B show an example of an alternative optical stylus configuration. Like the implementation shown in FIG. 10, this implementation includes an internal partially reflective surface 1005 within the deformable tip 130. The internal partially reflective surface 1005 is capable of reflecting a portion of light 125a from the light source system 305 towards light sensors of the light sensor system 310. In this example, the material 1010 is a reflective liquid, such as water, mercury, etc. However, in alternative implementations, the material 1010 may be a solid or a gel. The internal partially reflective surface 1005 may be formed due to the difference in the refractive indices of the material 1010 and the material 1015.

In the example shown in FIGS. 12A and 12B, the light sensor system 310 does not include a widely distributed array of light sensors, but instead includes only a localized light sensor array disposed inside the upper surface 1220. The optical stylus 120 includes a diffuser 1215 in this implementation. The diffuser 1215 diffuses the reflected light 125a and causes the light 125a to be distributed across a relatively larger portion of the upper surface 1220 and the light sensor system 310.

In this example, the optical stylus 120 includes a layer of light-absorbing material 1205 disposed on an inner surface of the optical stylus body 1210. In some implementations, the light-absorbing material 1205 may include a black pigment and/or a rough surface capable of scattering light. By comparing the spatial distribution of flux 710c of FIG. 12A with the spatial distribution of flux 710d of FIG. 12B, it may be seen that the flux of light reflected from the internal partially reflective surface towards the light-absorbing material varies according to the amount of optical stylus tilt. This decrease in flux is due in part to absorption of the light 125a by the light-absorbing material 1205.

Accordingly, in this example the control system 315 is capable of receiving light sensor data from the light sensor system 310 and of determining an amount of optical stylus tilt according to the light sensor data. The light sensor data may indicate changes in flux of light received by one or more optical sensors of the light sensor system 310. The control system 315 may be capable of determining the amount of optical stylus tilt according to the changes in flux. Alternatively, or additionally, the light sensor data may indicate changes in a spatial distribution of flux of light received by the light sensor system 310. The control system 315 may be capable of determining the amount of optical stylus tilt according to the changes in the spatial distribution of flux.

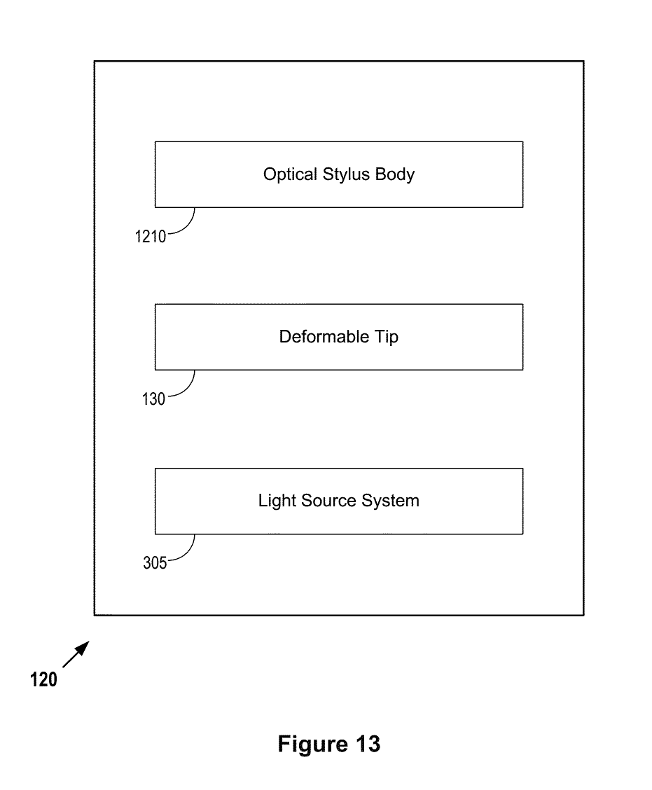

FIG. 13 is a block diagram that shows example elements of an alternative optical stylus. In this implementation, the optical stylus 120 includes an optical stylus body 1210, a deformable tip 130 and a light source system 305. In some such implementations, the deformable tip 130 may include a waveguide system. According to some such implementations, the light source system 305 may be capable of injecting light into the waveguide system. As noted elsewhere herein, in some implementations the optical stylus 120 does not necessarily include its own light sensor system.

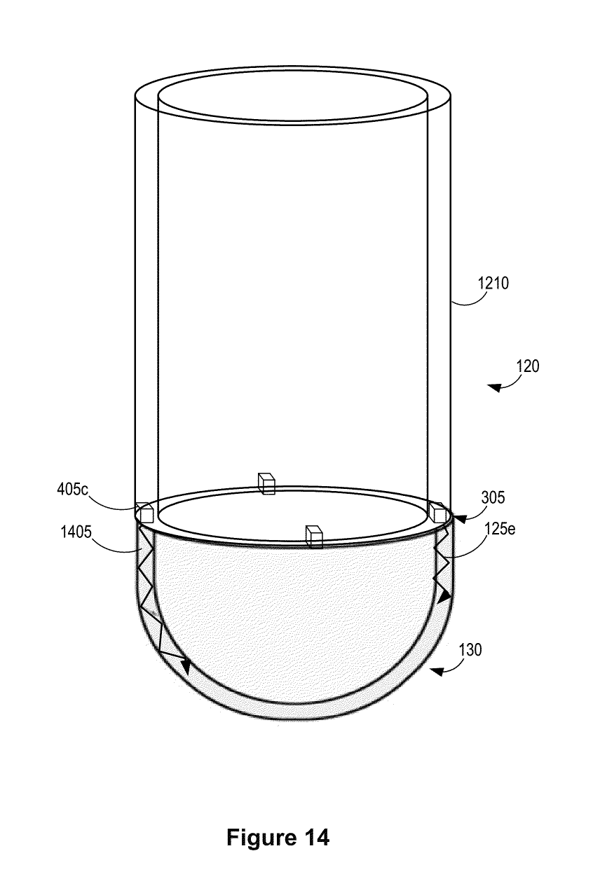

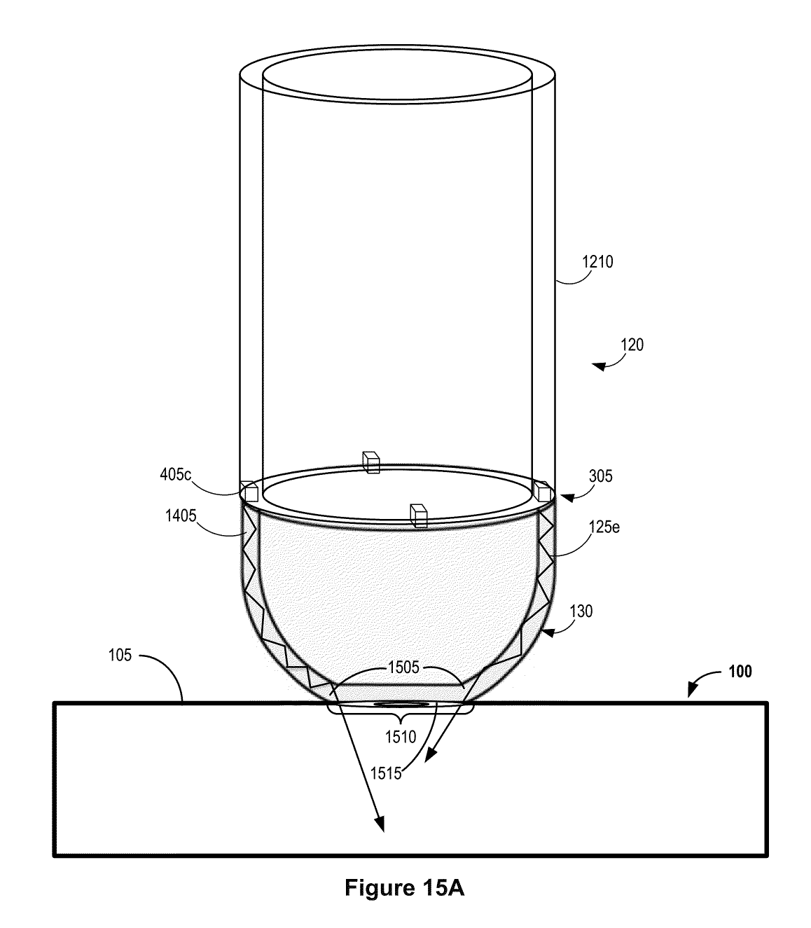

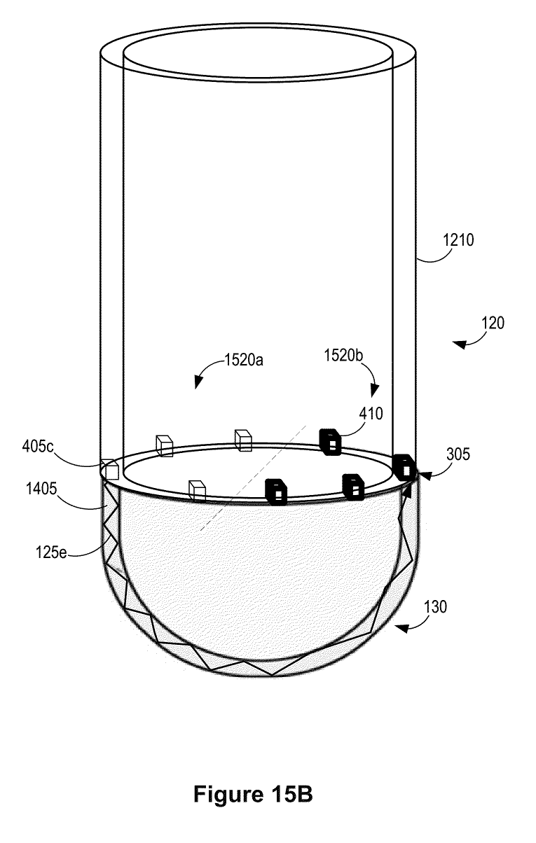

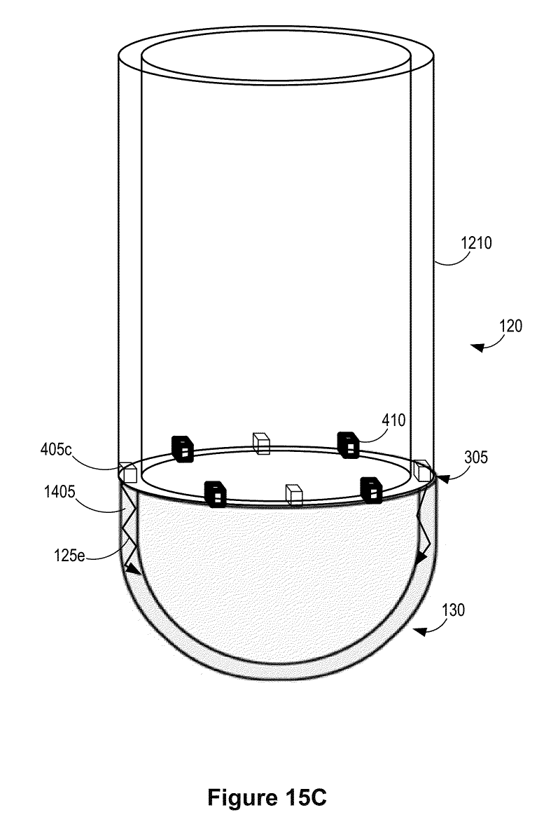

FIGS. 14 and 15A show examples of an optical stylus having a waveguide in a deformable tip. FIG. 14 shows the deformable tip 130 in an un-deformed state, during which time the optical stylus 120 is not being pressed against a light guide or other surface. In this example, the deformable tip 130 is hollow, with air on the inside and the outside of the deformable tip 130. The deformable tip 130 is formed of a flexible and substantially transparent material, such as an elastomer. Because flexible and substantially transparent materials will generally have a higher index of refraction than that of air, the walls of the deformable tip 130 can function as a waveguide 1405: the deformable tip 130 can function as a waveguide core, having a relatively higher index of refraction, and the air can function as the lower-index “cladding” layers. However, in alternative implementations, the deformable tip 130 may not be hollow. Instead, the deformable tip 130 may, for example, be filled with material that has a lower index of refraction than that of the outer surface.

In this implementation, a light source system 305 of the optical stylus 120 includes light source elements 405c, which are capable of injecting light 125e into the waveguide 1405. For example, the light source elements 405c may include laser diodes or VCSELs that are optically coupled to the waveguide 1405. Although four light source elements 405c are shown in this example, alternative implementations may include more or fewer of the light source elements 405c.

In this example, the optical stylus body 1210 is a hollow tube. Here, the optical stylus body 1210 has a thickness that matches the thickness of the waveguide 1405. However, in other implementations the optical stylus body 1210 may be solid or may have a thickness that is not substantially the same as that of the waveguide 1405.

FIG. 15A shows the deformable tip 130 in a deformed state. Here, the optical stylus 120 is being pressed against a surface, which is the surface of a light guide 105 of an optical touch/proximity sensing apparatus 100 in this example. In this implementation, the applied pressure causes deformable walls of the deformable tip 130 to form kinked portions 1505 in a contact area 1510 in which the deformable tip 130 is pressed against the light guide 105. Here, the kinked portions 1505 of the contact area 1510 form an annulus 1515, in which light 125e from the waveguide 1405 may be coupled to an optically transmissive surface, which is the light guide 105 in this example. In this implementation, increasing the pressure applied to the optical stylus 120 increases the size of the contact area 1510 and of the annulus 1515. In alternative examples, at least some light 125e may be provided throughout the contact area 1510.

In some implementations, a light sensor system of the optical touch/proximity sensing apparatus 100 (e.g., a light sensor system 110 such as that shown in any of FIGS. 1A-2) may be capable of detecting changes in the flux of light 125e provided to the light guide 105 caused by changes in the pressure applied to the optical stylus 120. For implementations of the optical stylus 120 such as that shown in FIGS. 14 and 15, the flux of light 125e provided to the light guide 105 increases as increasing pressure is applied to the optical stylus 120. A control system of the optical touch/proximity sensing apparatus 100 (such as the control system 150 shown in FIG. 1C and described above) may be capable of receiving light sensor data from the light sensor system corresponding to the changes in the flux of light 125e provided to the light guide 105. The control system may be capable of determining changes in the pressure applied to the optical stylus 120 according to the light sensor data.

FIGS. 15B and 15C show alternative examples of optical styli that include a waveguide in a deformable tip. In implementations such as those shown in FIGS. 15B and 15C, light sensors 410 of the optical stylus 120 may be capable of detecting changes in flux, such as decreases in flux, when the deformable tip 130 is pressed against a surface. Accordingly, in such implementations the optical stylus 120 may be capable of determining pressure applied to the deformable tip 130 without relying on a light sensor system of an optical touch/proximity sensing apparatus to detect increases in flux caused by pressing the deformable tip against the light guide.

In the example shown in FIG. 15B, the optical stylus 120 includes a plurality of light source elements 405c and light sensors 410, which are coupled to a waveguide 1405 of the deformable tip 130 in this example. In this implementation, the light source elements 405c are formed in a first portion 1520a of the deformable tip 130 and the light sensors 410 are formed in a second portion 1520b of the deformable tip 130. Accordingly, the light 125e provided by the light source elements 405c to the waveguide 1405 originates in the first portion 1520a and may be detected by the light sensors 410 in the second portion 1520b.

In the example shown in FIG. 15C, the light source elements 405c and the light sensors 410 are not grouped into separate portions of the deformable tip 130, but instead are distributed around the perimeter of the deformable tip 130. In this example, instances of the light source elements 405c are positioned between instances of the light sensors 410. Accordingly, the light 125e provided by the light source elements 405c to the waveguide 1405 originates in various locations of the deformable tip 130 and may be transmitted in multiple directions by the waveguide 1405.

In both the implementation shown in FIG. 15B and that shown in FIG. 15C, more of the light 125e provided by the light source elements 405c remains in the waveguide 1405 if the deformable tip 130 is in an un-deformed state, as compared to a deformed state when the deformable tip 130 is being pressed against a light guide. When the deformable tip 130 is being pressed against a light guide (e.g., as shown in FIG. 15A), some of the light 125e may be coupled into the light guide. Accordingly, the light sensors 410 may be capable of detecting decreases in flux of the light 125e when the deformable tip is pressed against a light guide.

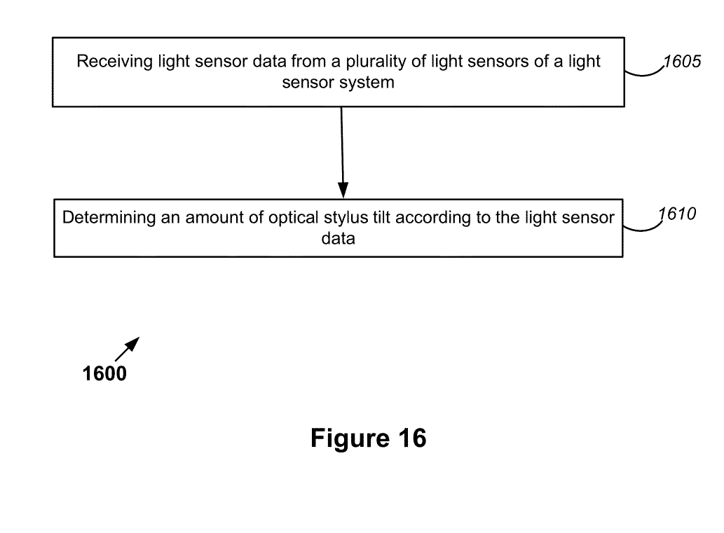

FIG. 16 is a block diagram that outlines one implementation of a method of determining optical stylus tilt. In this example, block 1605 involves receiving light sensor data from a plurality of light sensors of a light sensor system. As noted above, in some implementations the light sensor system may be part of an optical stylus 120. However, in alternative implementations the light sensor system may be part of an optical touch/proximity sensing apparatus 100.

In this implementation, block 1610 involves determining an amount of optical stylus tilt according to the light sensor data. In some implementations, the light sensor data may indicate changes in flux of light received by one or more of the optical sensors. The determining process may involve determining the amount of optical stylus tilt according to the changes in flux. In some implementations, the light sensor data may indicate changes in a spatial distribution of flux of light received by the light sensor system. The determining process may involve determining the amount of optical stylus tilt according to the changes in the spatial distribution of flux.

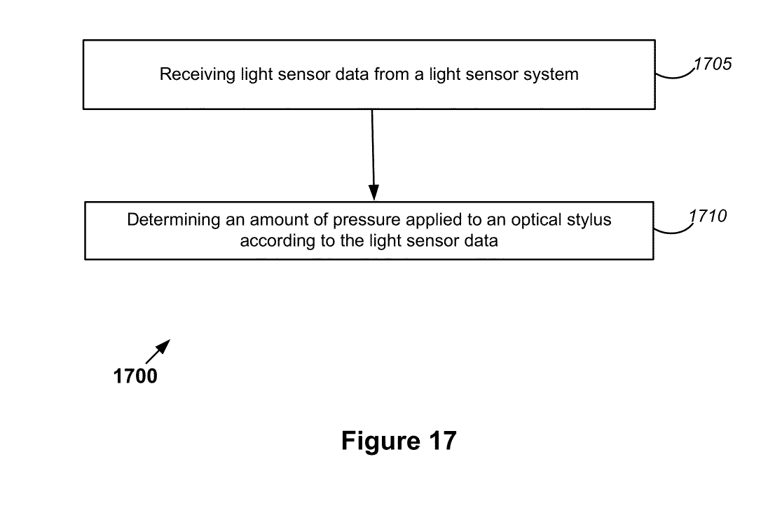

FIG. 17 is a block diagram that outlines one implementation of a method of determining an amount of pressure applied to an optical stylus. In this example, block 1705 involves receiving light sensor data from a light sensor system. In some implementations the light sensor system may be part of an optical stylus 120. Accordingly, the receiving process may involve receiving light sensor data from a plurality of light sensors disposed in the optical stylus. In other implementations, the light sensor system may be part of an optical touch/proximity sensing apparatus 100. In some such implementations, the receiving process may involve receiving light sensor data from a plurality of light sensors disposed on the periphery of a waveguide (such as the light guide 105 disclosed herein) to which the optical stylus 120 is providing light.

In this implementation, block 1710 involves determining an amount of pressure applied to an optical stylus according to the light sensor data. For implementations in which the receiving process involves receiving light sensor data from a plurality of light sensors disposed on the periphery of a waveguide, the determining process may involve determining changes in the intensity and/or the distribution of light received from the optical stylus.

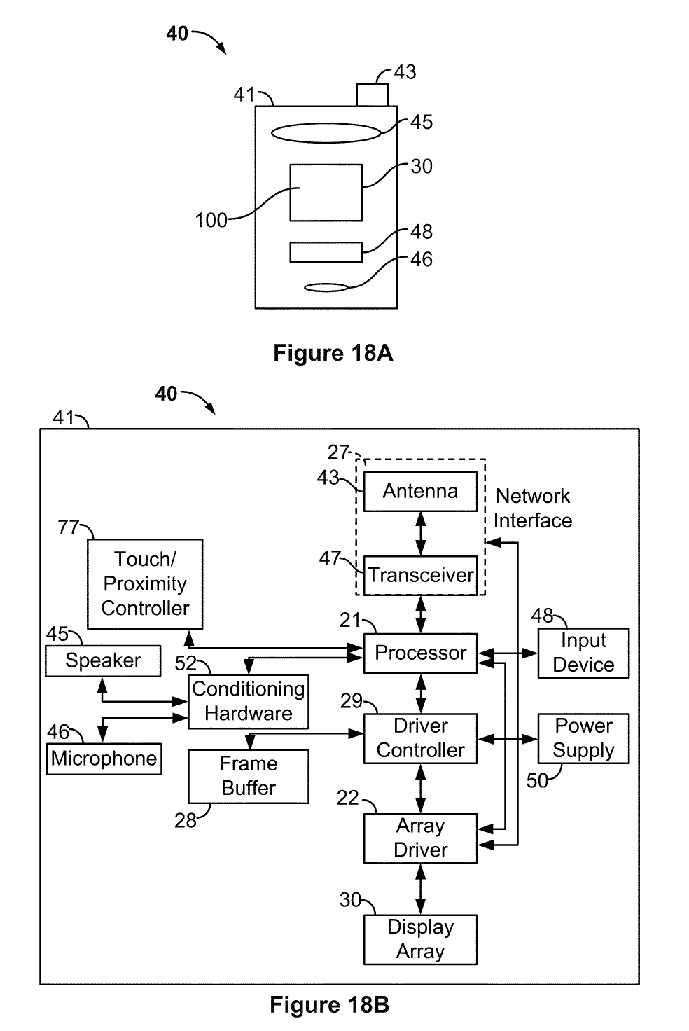

FIGS. 18A and 18B show examples of system block diagrams illustrating a display device that includes a touch/proximity sensing apparatus as described herein. The display device 40 can be, for example, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, a touch/proximity sensing apparatus 100, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can include a flat-panel display, such as plasma, EL, OLED, STN LCD, or TFT LCD, or a non-flat-panel display, such as a CRT or other tube device. In addition, the display 30 can include an IMOD-based display, as described herein. In this example, touch/proximity sensing apparatus 100 overlies the display 30.

The components of the display device 40 are schematically illustrated in FIG. 18B. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be capable of conditioning a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 10B, can be capable of functioning as a memory device and be capable of communicating with the processor 21. In some implementations, a power supply 50 can provide power to substantially all components in the particular display device 40 design.

In this example, the display device 40 also includes a touch/proximity controller 77. The touch/proximity controller 77 may be capable of communicating with the touch/proximity sensing apparatus 100, e.g., via routing wires, and may be capable of controlling the touch/proximity sensing apparatus 100. The touch/proximity controller 77 may be capable of determining a touch location of a finger, a stylus, etc., proximate the touch/proximity sensing apparatus 100. The touch/proximity controller 77 may be capable of making such determinations based, at least in part, on detected changes in light flux in the vicinity of the touch or proximity location. For example, the touch/proximity controller 77 may be capable of making such determinations based, at least in part, on light sensor data from a light sensor system (such as the light sensor system 110 of FIG. 1C). In alternative implementations, however, the processor 21 (or another such device) may be capable of providing some or all of this functionality. Accordingly, a control system 150 as shown in FIG. 1C and described elsewhere herein may include the touch/proximity controller 77, the processor 21 and/or another element of the display device 40.

The touch/proximity controller 77 (and/or another element of the control system 120) may be capable of providing input for controlling the display device 40 according to the touch location. In some implementations, the touch/proximity controller 77 may be capable of determining movements of the touch location and of providing input for controlling the display device 40 according to the movements. Alternatively, or additionally, the touch/proximity controller 77 may be capable of determining locations and/or movements of objects that are proximate the display device 40. Accordingly, the touch/proximity controller 77 may be capable of detecting finger or stylus movements, hand gestures, etc., even if no contact is made with the display device 40. The touch/proximity controller 77 may be capable of providing input for controlling the display device 40 according to such detected movements and/or gestures.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be capable of allowing, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be capable of functioning as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be capable of receiving power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus. above-described optimization

If implemented in software, the functions may be stored on or transmitted over as one or more instructions or code on a computer-readable medium, such as a non-transitory medium. The processes of a method or algorithm disclosed herein may be implemented in a processor-executable software module which may reside on a computer-readable medium. Computer-readable media include both computer storage media and communication media including any medium that can be enabled to transfer a computer program from one place to another. Storage media may be any available media that may be accessed by a computer. By way of example, and not limitation, non-transitory media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD (or any other device) as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An optical stylus, comprising:
a light source system;
a light sensor system;
a deformable tip; and
a control system capable of:
receiving light sensor data from the light sensor system; and
determining an amount of pressure applied to the optical stylus according to the light sensor data.

2. The optical stylus of claim 1, wherein the light sensor data indicates changes in flux of light received by one or more optical sensors of the light sensor system and wherein the control system is capable of determining the amount of pressure applied to the optical stylus according to the changes in flux.

3. The optical stylus of claim 1, wherein the deformable tip includes an internal partially reflective surface.

4. The optical stylus of claim 3, wherein the internal partially reflective surface is capable of reflecting a portion of light from the light source system towards the light sensor system.

5. The optical stylus of claim 4, wherein an amount of light reflected from the internal partially reflective surface towards the light sensor system varies according to the amount of pressure applied to the optical stylus.

6. The optical stylus of claim 4, wherein at least some light provided by the light source system is collimated light.

7. The optical stylus of claim 4, further comprising an aperture that allows light from a light source of the light source system to be emitted from the optical stylus, wherein the internal partially reflective surface is disposed between the light source and the aperture.

8. The optical stylus of claim 1, wherein the deformable tip includes material having a high degree of transparency.

9. The optical stylus of claim 8, wherein an amount of light reflected from the deformable tip decreases with increasing pressure.

10. The optical stylus of claim 1, wherein the control system is also capable of determining an amount of optical stylus tilt according to the light sensor data.

11. The optical stylus of claim 1, wherein the deformable tip includes a waveguide system, further comprising a light source system capable of injecting light into the waveguide system.

12. The optical stylus of claim 11, wherein the waveguide system is disposed within deformable walls of the deformable tip.

13. The optical stylus of claim 12, wherein the deformable walls are capable of forming kinked portions when the deformable tip is pressed against a surface.

14. The optical stylus of claim 13, wherein the kinked portions are capable of coupling light from the waveguide system into an optically transmissive surface.

15. An optical stylus, comprising:
a light source system;
a light sensor system;
a deformable tip; and
control means for:
receiving light sensor data from the light sensor system; and
determining an amount of pressure applied to the optical stylus according to the light sensor data.

16. The optical stylus of claim 15, wherein the light sensor data indicates changes in flux of light received by one or more optical sensors of the light sensor system and wherein the control means includes means for determining the amount of pressure applied to the optical stylus according to the changes in flux.

17. The optical stylus of claim 15, wherein the deformable tip includes internal partially reflective means for reflecting a portion of light from the light source system towards the light sensor system.

18. The optical stylus of claim 17, wherein an amount of light reflected from the internal partially reflective means towards the light sensor system varies according to the amount of pressure applied to the optical stylus.

19. The optical stylus of claim 17, further comprising an aperture that allows light from a light source of the light source system to be emitted from the optical stylus, wherein the internal partially reflective means is disposed between the light source and the aperture.

20. The optical stylus of claim 15, wherein the deformable tip includes material having a high degree of transparency and wherein an amount of light reflected from the deformable tip decreases with increasing pressure.

21. The optical stylus of claim 15, wherein the control includes means for determining an amount of optical stylus tilt according to the light sensor data.

22. The optical stylus of claim 15, wherein the deformable tip includes waveguide means for guiding light, further comprising a light source system capable of injecting light into the waveguide means.

23. The optical stylus of claim 22, further comprising means for coupling light from the waveguide means into an optically transmissive surface when the deformable tip is pressed against the optically transmissive surface.

24. A non-transitory medium having software stored thereon, the software including instructions for controlling at least one device for:
receiving light sensor data from a light sensor system; and
determining an amount of pressure applied to an optical stylus according to the light sensor data.

25. The non-transitory medium of claim 24, wherein the receiving involves receiving light sensor data from a plurality of light sensors disposed in the optical stylus.

26. The non-transitory medium of claim 24, wherein the receiving involves receiving light sensor data from a plurality of light sensors disposed on the periphery of a waveguide to which the optical stylus is providing light.

27. A method, comprising:
receiving light sensor data from a light sensor system; and
determining an amount of pressure applied to an optical stylus according to the light sensor data.

28. The method of claim 27, wherein the receiving involves receiving light sensor data from a plurality of light sensors disposed in the optical stylus.

29. The method of claim 27, wherein the receiving involves receiving light sensor data from a plurality of light sensors disposed on the periphery of a waveguide to which the optical stylus is providing light.

30. The method of claim 29, wherein the determining involves determining changes in at least one of the intensity or distribution of light received from the optical stylus.
